(19) United States
(12) Patent Application Publication
(10) Pub. No.: US 2010/0305984 A1
(43) Pub. Date: Dec. 2, 2010

(54) INTERMODAL TRIP PLANNER

(75) Inventors: Ophir Ben-Yitschak, Bayside, WI (US); Yoram P. Nissenboim, Haifa (IL); James A. Graziano, II, Green Bay, WI (US)

Correspondence Address: RATHE PATENT & IP LAW, 10611 W. HAWTHORNE FARMS LANE, MEQUON, WI, 53097, US

(73) Assignee: Scopia, LLC

(21) Appl. No.: 12/787,394

(22) Filed: May 26, 2010

Related U.S. Application Data
(60) Provisional application No. 61/183,059, filed on Jun. 1, 2009.

(51) Int. Cl. G06F 17/30; G06Q 10/00; G06Q 30/00

(52) U.S. Cl. 705/6; 707/752; 707/769; 707/E17.044; 707/E17.014

(57) ABSTRACT

A method and apparatus identify a set of trips satisfying base criteria, at least some of the trips comprising a series of trip segments connected to an intermediate location between an origin location and the destination location. Each intermediate location is connected to only two of the trip segments. At least two of the trip segments have different transportation modes. The method and apparatus further identify a subset of the trips that satisfy secondary criteria.

### CROSS REFERENCE TO RELATED APPLICATIONS

The present application claims priority under 35 U.S.C. §119(e) from co-pending U.S. Provisional Patent Application Ser. No. 61/183,059 filed on Jun. 1, 2009 by Ophir Ben-Yitschak, Yoram P. Nissenboim and James A. Graziano II and entitled INTERMODAL TRIP PLANNER, the full disclosure of which is hereby incorporated by reference.

### BACKGROUND

Portions of a single trip between two or more locations may have multiple available modes of transportation which connect between them to form a single itinerary. As a result, such trips may have complex itineraries and may be difficult to optimize for cost, preferences, requirements and convenience.

### BRIEF DESCRIPTION OF THE DRAWINGS

FIG. 1 is a schematic illustration of a trip planner according to an example embodiment.

FIG. 2 illustrates an example user or traveler profile display.

FIGS. 3A-3F are diagrams representing trips between an origin location and a destination location as identified by the trip planner of FIG. 1.

FIG. 4 illustrates an example output display.

FIG. 5 is a flow diagram of a method that may be carried out by the trip planner of FIG. 1.

FIG. 6 is a schematic illustration of a trip planning system including the trip planner FIG. 1 according to an example embodiment.

FIG. 7 is a flow diagram of a trip planning method that may be carried out by the system of FIG. 6.

FIG. 7A is a graph/schema illustrating the formation of a database of trips between locations.

FIGS. 8A and 8B illustrate a flow diagram of a trip pricing method that he carried out by the trip planning system of FIG. 6.

FIG. 9 is a flow diagram of a trip planning method that may be carried out by the system of FIG. 6, wherein the trip includes an overnight stay.

FIG. 10 is a flow diagram of the trip planning method that may be carried out by the system of FIG. 6, wherein the trip is goal or target oriented.

### DETAILED DESCRIPTION OF THE EXAMPLE EMBODIMENTS

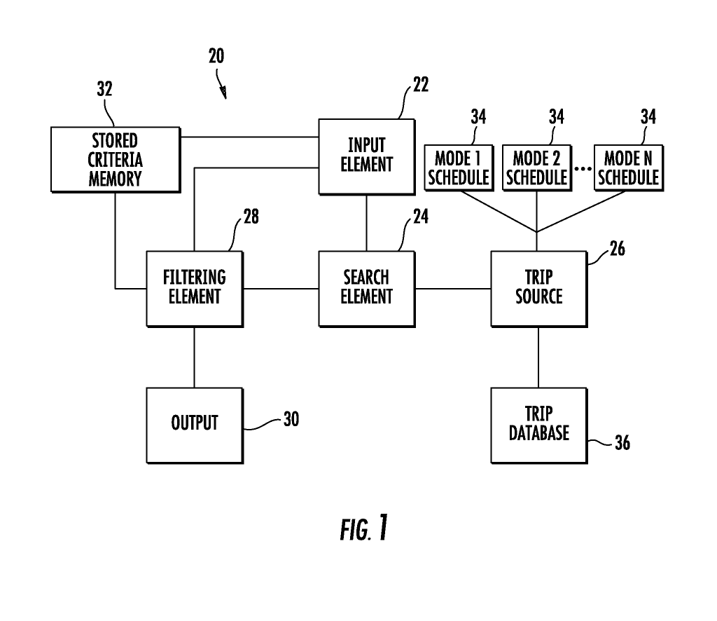

FIG. 1 is a schematic illustration of an intermodal-modal trip planner 20 according to an example embodiment. As will be described hereafter, trip planner 20 utilizes traveler preferences or criteria to provide a complete travel package including detailed trip itinerary utilizing multiple modes of transportation. The trip itinerary includes a series of end-to-end transportation modes, reducing complexity and simplifying travel.

Trip planner 20 is at least partially embodied as a computer program or programs contained on one or more computing devices or servers at one or more locations, wherein trip planner 20 interacts with individuals via one or more input and output devices. Examples of input devices by which trip planner 20 interacts with travelers or users will include, but are not limited to, a keyboard, a mouse, a touchpad, a touch screen, a microphone and speech recognition software, switches, buttons, mobile device and the like. Examples of output devices by which trip planner 20 may interact with travelers include monitors, television screens, printers, personal data assistants (PDA) devices, speakers and the like.

Trip planner 20 provides instructions which are carried out by one or more processors or processing devices or units located on a single computing device or multiple computing devices connected to one another by the Internet or by a network. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described.

Trip planner 20 generally comprises input element 22, search element 24, trip source 26, filtering element 28 and output element 30. Each of input element 22, search element 24, trip source 26, filtering element 28 and output element 30 comprises a computable readable program or instructions (or part of a computer readable program) written on computer readable medium (software on a memory) are hardwired (such as with an ASIC) and configured to direct one or more processing units to carry out one or more processes. In some embodiments, trip planner 20 may be provided as part of an overall system which additionally includes the processor or computing device, the output device and the input device described above. Input element 22 comprises that part of a computer program or a separate computer program configured to cause a display or other output device to prompt a traveler to present prompts requesting that a potential traveler input data including information about himself or herself. Examples of personal information that may be requested include the traveler's name, address, phone number, fax, passport information, visa information, health/vaccinations information and other personal information. Input element 22 may further request information such as the traveler's frequent flyer accounts, hotel and travel rewards program accounts, credit card information and the like. To facilitate access to such accounts for potential usage of received bonuses or awards, input element 22 may further request usernames, passwords or other authorization information for such frequent flyer accounts or reward programs.

In addition to requesting information about the traveler or groups of travelers, input element 22 may further request information regarding desired travel including base criteria and secondary criteria. Base criteria comprise base factors or base filters by which a universe of available trips may be filtered or narrowed down. For purposes of this disclosure, the term “trip” comprises a single segment from an origin location to a destination location or a series of one or more connected trip segments from an origin location to a destination location, wherein an endpoint of each segment is connected to at most one other segment. A trip may either be a one-way trip wherein trip segments only provide travel from an origin location to a destination location, may be a round-trip, wherein a first set of trip segments provide travel from the origin location to the destination location, and a second set of trip segments extends from the destination location back to the origin location or may be an “open jaw” wherein a first set of trip segments provide travel from the origin location to the destination location, and a second set of trip segments extends from a different destination location back to the origin location, or may be a “reverse open jaw” wherein a first set of trip segments provide travel from the origin location to the destination location, and a second set of trip segments extends from the destination location back to a different origin location, or may be a multiple-destination trip wherein a first set of trip segments provide travel from the origin location to the destination location, a second set of trip segments extends from the destination location to another destination location, a third set of trip segments extends from the first destination location to a second destination location, and so on, until the final segment extends from the last destination location back to the origin location. Base criteria comprise a geographic location from which the one or more individuals are traveling (the origin location), a geographic location to which the one of more individuals are traveling (the destination location), a time or range of times that travel is to begin (departure time from the origin location) and a time or range of times that travel is to be completed (arrival time at the destination location). For round trips, base criteria may additionally include a range of departure times from the destination location and a range of arrival times at the origin location.

An origin location may be a terminal origin location or a remote origin location. For purposes of this disclosure, a terminal origin is a location that serves as a hub or terminal for a mode of transportation such as a train station, an airport, a bus station, a subway terminal and the like. A remote origin location is a location that does not normally serve as a hub for a mode of transportation, such as a traveler's home or business office. A destination location may be either a terminal destination location or a remote destination location. For purposes of this disclosure, a terminal destination is a location that serves as a hub or terminal for a mode of transportation such as a train station, an airport, a bus station, a subway terminal and the like. A remote destination is a location that does not serve as a hub for a mode of transportation, such as a hotel, a park, a scenic site, a business office and the like. In one embodiment, trip planner 20 may accommodate base criteria that include one or more of a remote origin, a terminal origin, a terminal destination or a remote destination. In other embodiments, trip planner 20 may only accommodate a terminal origin and a terminal destination.

Secondary criteria comprise additional factors or filters used by trip planner 20 to additionally focus a search to narrow down a number of trips from all the initially found trips that satisfy the base criteria. Secondary criteria include availability and other traveler preferences. Availability means those trips for which every element or aspect of the trip, which satisfies the base criteria, is available for selection. In other words, there are available seats on each of the modes of transportation during the various segments of the trip or there are available rooms or beds at overnight accommodations when two consecutive segments are joined by an overnight stay at a hotel or motel accommodation. For example, many trips may satisfy the base criteria; however, some of those trips may include one or more trip segments in which a mode of transportation for the one or more trip segments has no available seats or room left. Those trips in which one or more trip segment have a mode of transportation in which all seats are filled or booked are removed or eliminated from the set of trips and are subsequently further filtered using the remaining secondary criteria comprising traveler preferences.

The other traveler preferences that form secondary criteria are input by input element 22. Examples of such traveler preferences include, but are not limited to, bonus availability (such as the ability to use bonus property such as frequent flyer miles, travel credits, discounts and the like), bonus savings (the amount of money that must be saved before expenditure of the traveler's bonus property), the rewarding of a bonus (frequent flyer miles) for use of particular carrier or provider, a maximum or minimum layover time between consecutive segments or for an overall trip, a maximum or minimum number of layovers during a trip, the maximum layover cost (a cost based upon the amount of layover time multiplied by a monetary value for each hour of the traveler's time during a layover as defined by the traveler), travel mode exclusions or preferences (such as whether the traveler prefers to travel by a particular mode of transport or disfavors a particular mode of transport (airplane, ship, train, bus, taxi, car rental, bicycle, Segway etc.)), mode of transportation sub preferences defining traveler likes or dislikes on a particular mode of transportation such as whether the traveler prefers a particular brand or carrier/renter for a mode of transportation (United, Delta, Greyhound, Amtrak, Avis) or such as a particular size or type of mode vehicle (a jet type or minimum size, a ship size, a car rental size, type or model), such as whether the traveler prefers to check bags or luggage and the number of bags or luggage items that are expected to be checked, whether the traveler has a preferred seat or floor location on the mode vehicle (window, aisle, front, back, lower-level, upper level, floor level) or a preferred class or level (economy, business class, first-class), overnight exclusions or preferences (such as whether the traveler is okay with an overnight stay between trip segments or wishes to avoid overnight or redeye flights), overnight accommodation exclusions or preferences (such as any hotels, motels or resorts that the traveler likes or dislikes) or features or amenities that the accommodation should have (such as fitness facilities, free internet, wireless internet, pool, breakfast, restaurant), overnight accommodation sub preferences defining preferences/amenities at a particular hotel, motel or resort such as the type of room (balcony, ocean view, garden view, pool side, floor) or the type of beds in the room (king, queen, double). In circumstances where traveler may not have answered one or more of user or traveler preference secondary criteria, input element 22 may automatically fill in such information on behalf of the traveler using “fuzzy logic”, wherein the traveler's actual answers to other questions are used to predict or estimate the traveler preference for the preference is not specifically identified by the traveler. In particular embodiments, input element 22 and further request that the traveler weigh or prioritize one or more of the input preferences or secondary criteria. In other embodiments, input element 22 may be configured to facilitate the input of additional secondary criteria or a fewer number of the above-mentioned secondary criteria.

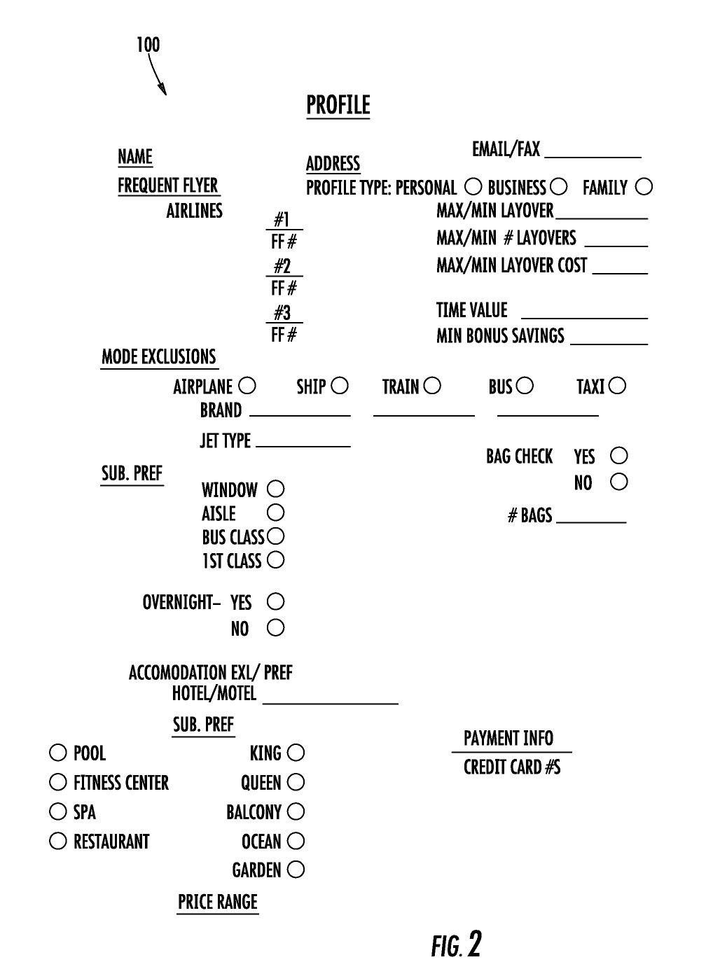

The secondary criteria that are input (the user preferences) are transmitted and utilized directly by filtering element 28 or are stored in a memory 32 as part of a traveler profile. FIG. 2 illustrates one example of a traveler profile 100 that may be created by input element 22 upon the receipt of selections, preferences or other data via the input device (keyboard, mouse etc.) from the traveler. In one embodiment, profile 100 is presented to a traveler on a display in substantially the same format as depicted in FIG. 2. In other words, input element 22 may cause a display to present the traveler preference secondary criteria as a form to be filled out by a traveler using his or her mouse and keyboard. In another embodiment, input element 22 may cause a processor to produce a display to present multiple screens, each screen having an individual prompt requesting an individual piece of data or requesting less than all of the traveler preference secondary criteria shown in FIG. 2 at any one time. In one embodiment, once all the individual slides have been made, input element 22 may cause a processor to produce a display to provide a confirmation screen in a format similar to that shown FIG. 2 depicting all of the traveler's selections and confirming their accuracy.

The traveler profile 100 is stored on a memory and is subsequently used by filtering element 28. In one embodiment, trip planner 20 may include multiple profiles containing secondary criteria that can be applied to different types of travel. For example, trip planner 20 may have a first profile 100 containing secondary criteria for business travel for a particular person. Trip planner 20 may have a second profile 100 containing secondary criteria for personal travel or vacation travel for the same particular person. Trip planner 20 may include a third profile containing secondary criteria designated for use when the particular individual travels with his or her family. Trip planner 20 may have a fourth profile containing secondary criteria that it made for use when the traveler travels within a certain range of distances, when the traveler travels in, to or from a particular region, state or country or when the customer or traveler travels during a particular time of the year.

Search element 24 comprises that part of a computer program or a separate computer program configured to utilize the input base criteria and to identify a set of trips from the universe of all trips, including trips to have multiple modes of transportation, satisfying the base criteria. In other words, search element 24 filters those particular trips that satisfy the base criteria out of the universe of all trips. The universe of all trips is provided by trip source 26.

Trip source 26 comprises that part of a computer program or a separate computer program configured to provide search element 24 with the universe of trips between different origin locations and different destination locations at multiple times, using different modes of transportation as well as different carriers in each mode. Examples of different modes of transportation, include, but not limited to, use of: a car, a shuttle service, a taxi, a limousine, a bus, a ferry, a rail (local (underground or subway, elevated rail and train), national and international) and air (scheduled (legacy) carriers, low-cost carriers, charter flights (publicly-marketed charter flights, private charter flights) and the seasonal flights). Each trip provided by trip source 26 comprises a single segment from an origin location to a destination location or a series of one or more connected trip segments from an origin location to a destination location, wherein an endpoint of each segment is connected to at most one other segment.

Trip source 26 formulates such trips by retrieving various itineraries or schedules for multiple modes of transportation from various mode schedules sources 34. Mode schedules sources 34 may comprise various Internet sites, various network or internet connected databases, schedule subscription services or schedules specifically retrieved from travel vendors and specially entered into a custom mode schedule for trip planner 20 or specifically created for use in trip planner 20 using information from vendors. In the example illustrated, trip source 26 is illustrated as retrieving schedules for N modes of transportation. For example, trip source 26 may retrieve schedules for airplanes, schedules for trains and schedules for buses. Some airplane schedules and train schedules are commercially available. However, other schedules, such as regional bus schedules and the like may not necessarily be commercially available. In such instances, such schedules may be specially acquired from mode suppliers or vendors and updated for use in trip planner 20. The rate or frequency at which such special schedules are maintained or updated may vary based upon how often such schedules change, based upon how often information from such particular schedules is used or based upon how often a particular mode carrier is chosen for travel. For example, an implementer or party operating trip planner 20 may specially create or purchase a database of schedules for a multiple bus carriers by contacting each of the bus carriers. The same may hold true for carriers and other modes of transportation for which schedules may not otherwise be commercially available.

In some embodiments, trip source 26 may additionally include trips having portions of which travel is independently achieved by the traveler such as when the travel mode utilizes a vehicle rental (car, motorcycle, Segway, etc.), a bicycle rental or the traveler's own vehicle such as when traveling to and from a remote origin (the traveler's home). In embodiments where trip source 26 allows such additional independent modes of transportation to be incorporated as part of the overall search, trip source 26 may calculate an estimated amount of time required by the traveler to travel the segment of the trip. The estimated amount of time may be at least partially based upon estimated traffic congestion, speed limits, likely weather conditions and steepness or terrain (especially in the case of bicycles). In such an embodiment, input element 22 may prompt a traveler to indicate how frequent he or she stops when independently traveling (this may vary if the traveler is traveling alone, if the traveler is traveling with others or if the traveler is traveling with small children). In those instances wherein the rate of travel may be dependent upon the traveler's health or fitness (such as when a segment of the trip may be potentially made by bicycle), input element 22 may further prompt the traveler to indicate his or her level of fitness or an estimated speed at which the traveler may achieve for the particular mode. In some embodiments, such information may be input and stored as part of the traveler profile. By formulating trips allowing independent travel modes (vehicle rental, bicycle and the like), trip planner 20 enables a traveler to form an even more customized travel itinerary and provides the traveler with greater freedom and fitness opportunities. As a result, trip planner 20 is especially suited for formulating unique vacation travel itineraries.

Using such mode schedules, trip source 26 identifies each combination of transportation modes that may be connected together to provide a series of trip segments extending from an origin location to a destination location and potentially back to the origin location. In one embodiment, trip source 26 assembles such trips regardless of whether all segments of the trips or desired features for such segments have room or available seating. In one embodiment, trip source 26 assembles trips for each and every potential origin location and destination location. In yet another embodiment, trip source 26 assembles such trips only after receiving base criteria from search element 24, wherein source 26 assembles trips that satisfy the base criteria provided it by search element 24.

According to one embodiment, trip source 26 automatically and periodically formulates and maintains a trip database 34. Rather than waiting for search element 24 to request what universe of trips are available, wherein trip source 26 would then go out and retrieve information from the various mode schedules, trip source 26 prepares, ahead of time, a database or series of databases of all available trips from multiple different origin locations OL to multiple different destination locations DL. For example, on either an hourly, daily, monthly or on some other periodic basis, trip source 26 may retrieve scheduling information for each of the multiple travel modes. On this periodic basis, trip source 26 formulates various trips and stores the formulated trips in a trip database 34. The universe of trips stored in trip database 34 includes trips from multiple origin locations OL to any of multiple destination locations DL. For example, a trip database may include trips from a traveler's business or workplace near Milwaukee, Wis. (a remote origin) to a customer or client near New York, N.Y. (a remote destination), from a traveler's home near Milwaukee, Wis. to a specific address in Rome, Italy, from a terminal origin near San Francisco, Calif. to a terminal destination near New York, N.Y., from a terminal origin near San Francisco, Calif. to a terminal destination near Rome Italy, from a traveler's home near Milwaukee, Wis. (a remote origin) to a particular resort in Orlando, Fla. (a remote destination), from a traveler's home near Milwaukee, Wis. (a remote origin) to a terminal destination near Los Angeles, Calif. and so on. The frequency at which trip source 26 prepares or assembles the universe of available trips between such multiple locations or the frequency at which trip source 26 updates this universe of available trips between such multiple locations may vary for different origin locations and different destination locations. For example, trip source 26 may update trips from our trips to a first location at a greater frequency as compared to trips to or trips from a second location which may be more remote than the first location or which is a less popular travel destination or origin as the first location. According to one embodiment, trip source 26 updates trip database 34 on a daily basis for at least a majority of destination locations. In one embodiment, trip source 26 may only formulate and store trips between terminal origins and terminal destinations, wherein trip segments between the remote origin and the terminal origin and between a terminal destination and a remote destination are identified, optimize and added by filtering element 28 prior to display by output 30. In other embodiments, trip source 26 may maintain a database including remote origins and/or remote destinations as part of the stored trips.

According to one embodiment, trip source 26 may only formulate and maintain/update trips having origin locations identified by subscribers or users to trip planner 20 when such subscribers or users create their individual profiles. For example, trip planner 20 may initially request that subscribers or users of trip planner 20 identify their home, place a business or other locations from which a trip of the traveler is most likely to originate. In such an embodiment, trip planner 20 may create and maintain a database 34 including only those trips having the identified home, place of business or other location as the origin location. As the number of travelers subscribing or using trip planner 20 increases, the universe of trips created and maintained by trip source 26 and stored in trip databases 34 will correspondingly increase.

Because trip planner 20 prepares a database 34 of trips between multiple origin locations and multiple destination locations, trip planner 20 may be more responsive and less time-consuming when a traveler inputs the base criteria and secondary criteria for travel. In other words, the traveler using trip planner 20 may not need to wait as long for results to be provided. The traveler does not need to wait for trip source 26 to actually create or formulate a list of all available trips before search element 24 can filter such trips using the base criteria.

In some embodiments, trip source 26 may forward trips from trip to search element 24 and may also concurrently update trips from schedules sources 34. For example, input element 22 of trip planner 20, when receiving base criteria from a traveler, may further ask the traveler whether he or she requires the most up-to-date information or whether he or she is willing to wait for the most up-to-date information. If the traveler indicates that he or she is willing to wait or requires the most up-to-date information, input element 22 may cause trip source 26 to specially update trip database 36 for the particular search requested by the traveler.

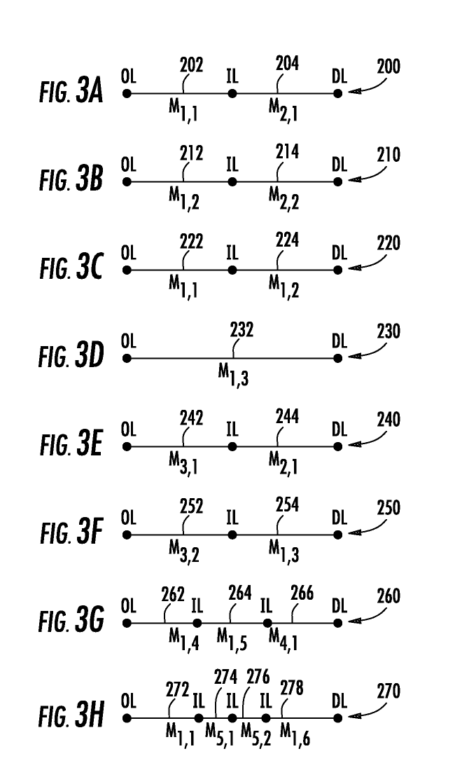

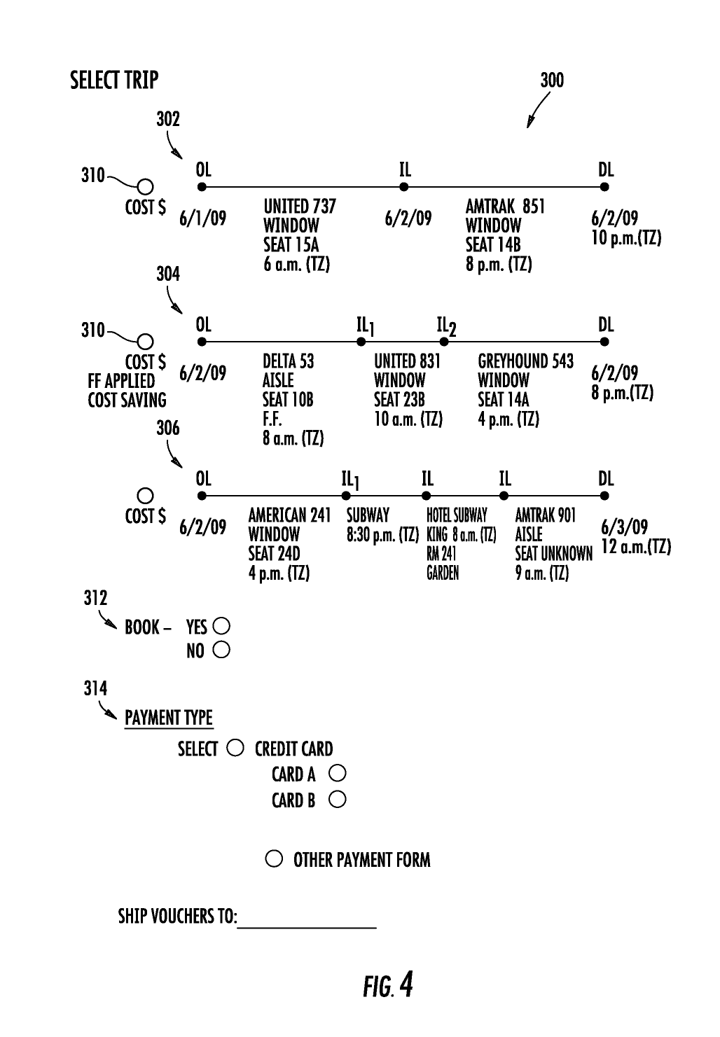

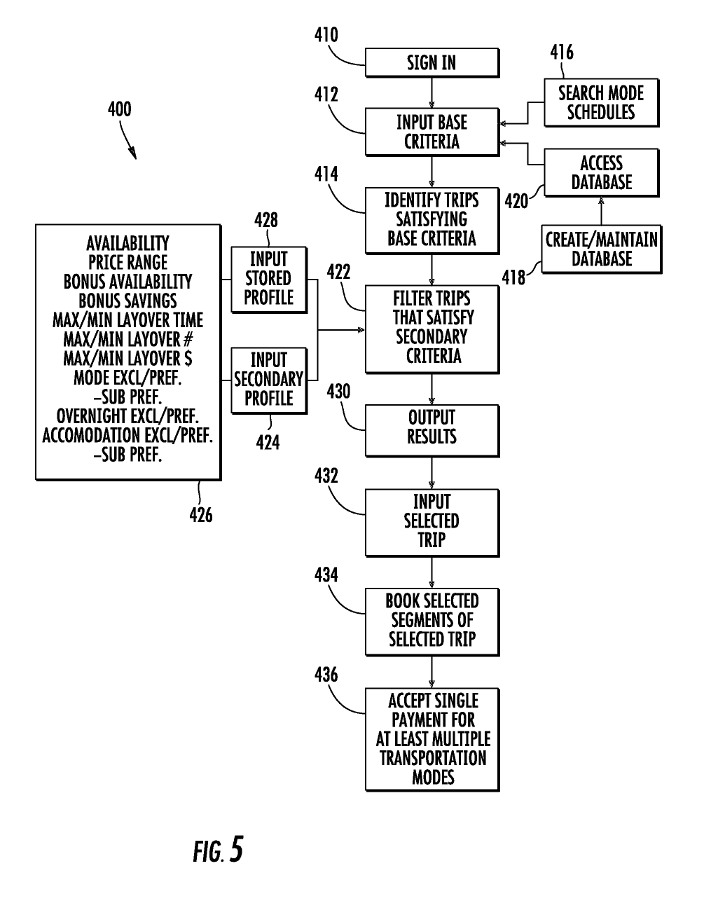

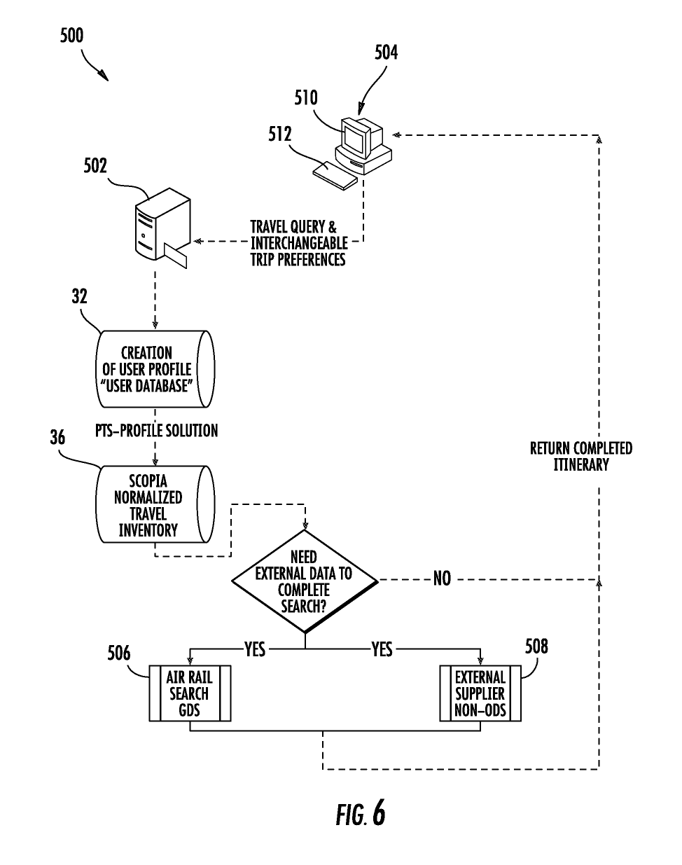

Upon receiving the universe of trips from trip source 26, search element 24 applies the base criteria received from input element 22. Search element 24 forwards the narrowed list of trips to filtering element 28. FIGS. 3A-3F illustrate an example narrowed list or narrowed universe of one-way trips forwarded to filtering element 28. Each of the trips schematically represented in FIGS. 3A-3H were originally part of the total universe of trips supplied by trip source 26. Each of the trips identified in FIGS. 3A-3F satisfy the basic criterion in that each of the trips are from the same input original location OL to the same destination location DL. Each of such trips have a departing date or time from the origin location OL and an arrival date or time at the destination location DL that satisfies the range of departure and arrival dates or times entered as base criteria by the traveler. FIGS. 3A-3F schematically or diagrammatically illustrate various trips having various combinations of travel modes. As a whole, each trip comprises a single segment from an origin location to a destination location or a series of one or more connected trip segments from an origin location to a destination location, wherein an endpoint of each segment is connected to at most one other segment. Although FIGS. 3A-3F illustrate example trips for a one-way trip search, other searches carried out by trip planner 20 may be for a round trip search or a multi-segment trip. In a round-trip search, each of the trips shown in FIGS. 3A-3F would additionally include one or more additional segments returning from the destination location to the origin location, forming a loop. As many modes of travel are sold as round-trip purchases, some segments of the outgoing portion of the trip (going from the origin location towards the destination location) may have the same carrier (provider, brand or source of travel mode such as United, Delta, Amtrak, Greyhound) as a corresponding segment of the return portion of the trip (going from the destination location back to the origin location). In a multi-segment trip, the traveler may stay at a particular intermediate location for several days.

FIG. 3A illustrates trip 200 including trip segments 202, 204. Trip segment 202 extends from origin location to an intermediate location or hub and utilizes transportation M_{1,1}. The first subscript number identifies a particular type or mode of transportation while the second subscript number identifies a specific carrier at a specific time. For example, the first subscript number 1 may represent a plane while a first subscript number 2 may represent a train. The second subscript number succeeding a first subscript number 1 may indicate a particular plane carrier (United, Delta etc,) as well as a particular flight (time and plane) for that carrier. The second subscript number succeeding a first of number 2 may indicate a particular train carrier as well as a particular run by the train. Trip segment 204 is connected to trip segment 202 at intermediate location IL and terminates at the destination location DL. Trip segment 204 utilizes transportation M_{2,1} having a mode 2 of transportation on a particular flight or run 1. As noted above, segment two of four may utilize a train as indicated by the first subscript number 2 and a particular train carrier at a particular time as indicated by the second subscript number 1.

FIG. 3B that diagrammatically illustrates trip 210 consisting of trip segments 212 and 214. Trip segment 212 extends from the origin location to an intermediate location. The intermediate location may not necessarily be the same as the immediate location of trip 200. Trip segment 212 utilizes transportation M_{1,2} while trip segment 214 utilizes transportation M_{2,2}. Trip 210 is similar to trip 200 in that trip 210 utilizes the same mode of transportation for trip segments 212 and the same mode of transportation for segment 214. However, trip segments 212 and 214 utilize different specific flights or runs. For example, although trip 202 and 212 utilize a plane as a mode of transportation, trip segments in the 202 and 212 utilize different specific plane flights. The plane flights may be at the same time, but with different carriers or may be at different times with the same carriers. Likewise, although segments 204 and 214 both utilize trains, trip segments 204 and 214 utilize different specific train runs. The train runs may be at the same time, but with different trains/carriers or may be at different times with the same trains/carriers.

FIG. 3C illustrates trip 220 consisting of trip segments 222 and 224. Trip segment two and 22 is identical to trip segment 202 as both utilize transportation M_{1,1}. As a result, the intermediate location of trip 220 is same as the intermediate location of trip 200. However, trip statement 224 is different from trip segments 204 in that trip segment 224 also utilizes the same mode of transportation as trip segment 222. In the example illustrated, both trip segments utilize a plane as indicated by the first subscript number 1. However, trip segments 222 and 224 utilize different specific plane flights. The plane flights of segments 222 and 224 may be on the same carrier or may be different carriers.

FIG. 3D illustrates trip 230. Trip 230 constitutes a single trip segment 232 utilizing transportation M_{1,3}. Trip segment 232 extends from origin location to destination location and utilizes same mode of transportation as trip segments or 202, 212, 222 and 224. In the example illustrated, trip segment 232 utilizes a plane. As indicated by the second subscript number 3, trip segment 232 utilizes a different flight (different carrier or different time) as compared to the aforementioned trip segments.

FIG. 3E illustrates trip 240 consisting of trip segments 242 and 244. Trip segment 242 utilizes yet a third different mode of transportation, a bus, as indicated by the first subscript number being a 3. Trip segment 244 utilizes same mode of transportation as trip segments 204 and 214. Trip segment 244 utilizes same specific train run as trip segment 204 (both are identified by the same second subscript number 1).

FIG. 3F illustrates trip 250 consisting of trip segments 252 and 254. Trip segment 252 is similar to trip segment 242 in that both trip segments 242 and 252 utilizes the same mode of transportation as indicated by the same first subscript number 3. However, trip segments 242 and 252 utilize different specific runs, either different bus carriers or the same bus carrier at different times. Trip segment 254 utilizes the same mode of transportation as trip segment 224, but utilizes a different flight (a different airline carrier or the same airline carrier at a different time).

FIG. 3G illustrates trip 260 consisting of trip segments 262, 264 and 266. Trip segment 262 utilizes the same mode of transportation as trip segment 202 as indicated by the first subscript number 1, but utilizes a different flight (same carrier a different time, different carrier, same time or different carrier different time) as indicated by the second subscript number 4. Trip segment 262 extends from the origin location to a first intermediate location. The first interview location may be the same as or different from the intermediate locations of any of trips 200, 210, 220, 230, 240 or 250. Trip segment 264 extends from the first intermediate location to a second intermediate location. The second intermediate location may be the same as or different from any of the intermediate locations of trips 200, 210, 220, 230, 240 or 250. Trip segment 264 utilizes the same mode of transportation as trip segment 262. Other trips made allies to promote transportation for segment 264 as compared to segment 262. Singer and 264 utilizes a different specific flight as compared to segment 262. Trip segment 266 utilizes yet a fourth mode of transportation, such as a water traveling vessel (aka ship, boat, ferry etc) as indicated by the first subscript number 4.

FIG. 3H illustrates trip 270 consisting of trip segments 272, 274, 276 and 278. Trip 270 includes an overnight stay at an accommodation 279. Trip segment 272 utilizes same transportation as trip segment 202, M_{1,1}, and terminates at the same intermediate location or hub as trip 200. Trip segment 274 utilizes a fifth mode of transportation, such as a subway, as indicated by the first subscript number 5. Trip segment 274 extends from the first intermediate location to a second intermediate location at which the hotel overnight accommodation 279 is located. An example illustrated, trip segment 274 goes from the airport to the hotel 279. Similarly, trip segment 276 utilizes the same mode of transportation as trip segment 274 but is at a different time. For example, trip segment 276 may start the next morning and go from the hotel to a third intermediate location, the departing location for trip segment 278 (the airport). Trip segment 278 extends from the third intermediate location to the destination location and utilizes the same mode of transportation as trip segment 272. Trips 200-270 illustrate but a few examples of various combinations of trip segments, modes of transport and overnight accommodations at the modes are between intermediate locations that may form the various trips stored in trip database 36 and subsequently narrowed down by search element 24 using base criteria.

Filtering element 28 comprises that part of a computer program or a separate computer program configured to apply one or more secondary criteria to be set of trips received from search element 24. In one embodiment, filtering element 28 initially filters out trips based upon availability. In other words, filtering element 28 removes from further consideration trips that, although satisfying the base criteria, are not available as no spaces or seats on at least one mode of transportation of at least one segment remain open for booking or reservations. After removing such unavailable trips from consideration, filtering element 28 proceeds by applying the above described user preference's secondary criteria. In one embodiment, filtering element 28 may directly receive such secondary criteria from input element 22. In another embodiment, filtering element 28 may retrieve the secondary criteria to be applied from a profile stored in memory 32. In some embodiments, filtering element 28 utilizes both secondary criteria retrieved from memory 32 as well as secondary criteria directly received from input element 22 during a particular traveler search.

Output 30 comprises that part of a computer program or a separate computer program configured to direct the computing device or processor to control a display or other output device so as to visibly and/or audibly present to a traveler the trips that remain after filter element 28 has removed those additional trips that, although satisfying the base criteria and although being available, still do not satisfy one or more traveler preference secondary criteria. In one embodiment, output 30 may present only those trips that satisfy all secondary criteria. In one embodiment, output 30 may present the remaining trips in the order of cost and least expensive to most expensive or vice versa.

In one embodiment, output 30 is configured to additionally list trips that satisfy most of the secondary criteria, but which may fail some criteria. By doing so, output 30 enables the traveler to reconsider or compromise on the importance of some of the secondary criteria given potential cost savings. For example, in one embodiment, input element 22 may be configured to prompt a traveler using planner 20 to identify a maximum number of preferences that need not necessarily be satisfied by an available trip for the available trip to still be displayed for potential selection. In yet another embodiment, input element 22 may be configured to prompt the traveler using planner 20 to weight or prioritize the importance of each of the secondary criteria as the traveler enters the secondary criteria. In such an embodiment, those available trips that only fail less important secondary criteria may still be presented by output 30 as a trip available for selection.

In embodiments where no single trip satisfies each and every traveler preference secondary criteria, output 30 may be configured to list available trips in order of the percentage of secondary criteria that are satisfied by each trip. In one embodiment, output 30 may be configured to present a maximum number or a minimum number of trips for selection. In such an embodiment, input element 22 may be configured to prompt a traveler for a maximum number, minimum number of trips that should be displayed regardless of how many trips actually satisfy all of the secondary criteria or how may trips even satisfy any of the secondary criteria.

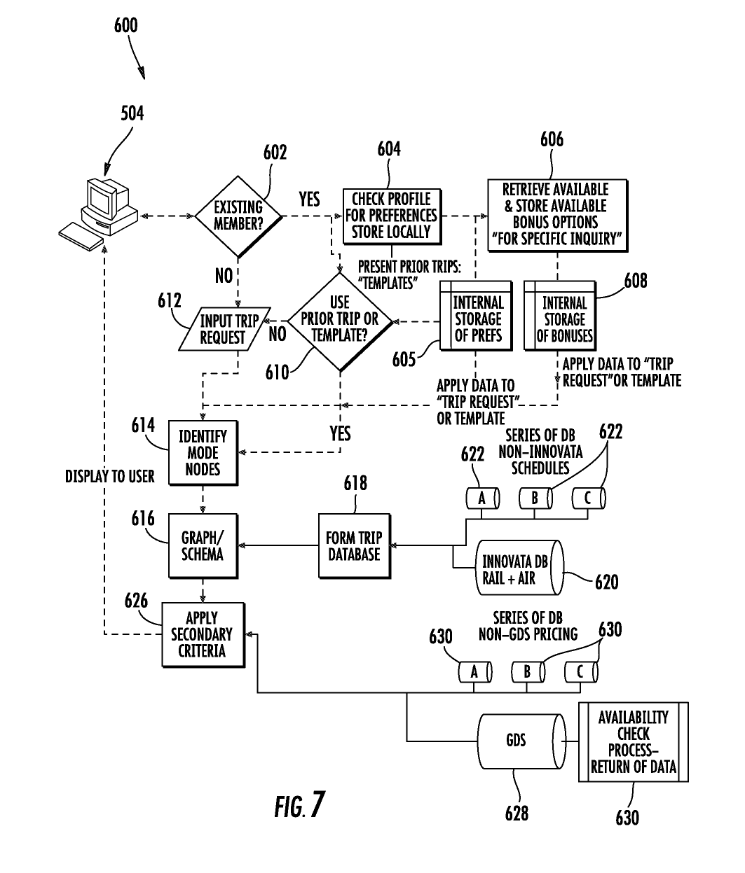

FIG. 4 is a sample of one output format 300 that may be utilized by output 30 to present trips that satisfy the base criteria, that are available and that sufficiently satisfy enough secondary criteria so as to be presented by output 30 for selection. In the example illustrated, a display screen identifies three different trips 302, 304 and 306 that satisfy the base criteria of traveling from a particular origin location OL to a particular destination location DL, that satisfy the input range of departure times and arrival times and that sufficiently satisfy the traveler preference secondary criteria. Each of trips 302, 304, 306 presented on the display screen identifies the origin location, the destination location and the one of more intermediate locations of the trip.

Trips 302, 304, 306 further identify the particular carrier (Delta, United, Greyhound, Amtrak, Subway), the particular flight or run (Delta 53, Greyhound 543, Amtrak 901) the departure time for the particular travel segment (6 AM, 4 PM, 8:30 PM etc.) and the seat assignment for the particular travel segment (see 24D, seat 14A etc.). In the example illustrated, “TZ” represents the time zone. For those trips that include an overnight stay, such as trip 306, the accommodation, room number, bed type and room type are also listed. In some embodiments, an address and contact information for the vendor of the particular mode of transportation or the particular overnight accommodation may additionally be listed. As a result, the traveler is provided with a step-by-step itinerary for travel from the origin location to the destination location. The traveler simply needs to follow the steps or segments identified by output 30. Because each trip segment has a starting node connected to only one other trip segment and an ending node connected to at most one other trip segment, the traveler is not required to identify a workable particular segment option or a particular flight or other mode run from a list of possible segments or a list of possible flights are other runs. Said another way, trip planner 20 connects all the travel dots for the user. As a result, traveler is less complex as compared to other trip planning which may require the traveler to identify workable individual connections between modes.

As further shown by FIG. 4, output 30 causes a computing device or processor to direct the display to further order trips 302, 304 and 306 in order of cost which is identified (cost $) for each trip 302, 304 and 306. As noted above, in other embodiments, such trips may alternatively be listed based upon the degree to which the trips satisfied the secondary criteria. In the example illustrated, output 30 further indicates whether or not any bonuses, frequent-flier awards, or other bonus discounts or credits have been applied and what cost savings have been achieved.

As indicated by the empty circles or checkboxes 310, the traveler is further prompted to select one of the trips for travel. As indicated by display portion 312, output 30 further prompts the traveler as to whether trip planner 20 should proceed with booking or reserving seats and accommodations for the trip. In the example illustrated, trip planner 20 books all segments and all accommodations via the Internet or by other communication. In yet other embodiments, output 30 may request that the traveler identify which segments that the traveler desires trip planner 20 to book and which segments that the traveler 20 desires to personally book himself or herself.

As indicated by display portion 314, if the traveler indicates that trip planner 20 is to book one of more segments of the selected trip, output 30 further instructs a computing device or processor to cause the display to prompt the traveler to input payment information and an address to which travel receipts or vouchers should be sent. Such travel vouchers may be sent by mail or electronically such as through an e-mail. In some embodiments, travel vouchers may simply be printed out by the traveler from the website providing travel planner 20. As a result, trip planner 20 further simplifies the making of travel arrangements by facilitating the booking of travel for different transportation modes associated with different segments of a trip and the acceptance of a single payment for different transportation modes or four the same transportation mode, but with different carriers. The single payment may also cover the cost of any overnight accommodations for the selected trip.

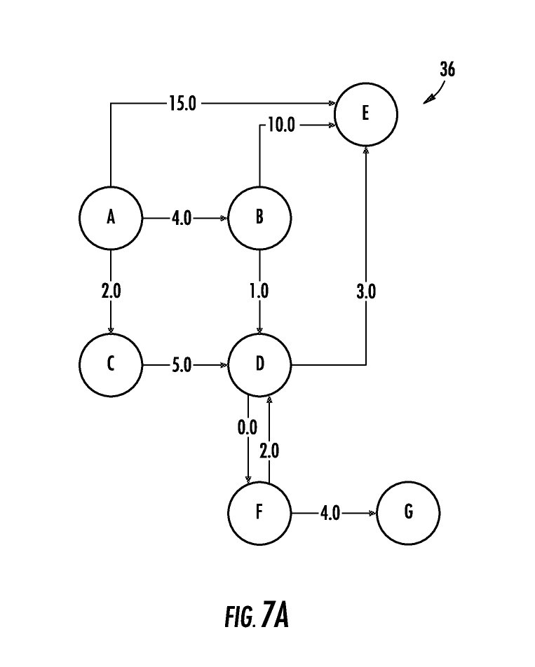

FIG. 5 is a flow diagram of one example process or method 400 carried out by trip planner 20. As indicated by step 410, input element 22 (shown in FIG. 1) of trip planner 20 initially requests a potential traveler to login or sign in. When signing in, the traveler provides trip planner 20 his or her identifying information such as his or her address, phone number, e-mail and other contact information. The traveler may further be requested to provide payment information and various account numbers and authorization data such as frequent-flier account numbers and authorization data allowing input system 20 to access such frequent flyer account information.

According to one embodiment, the traveler or user predefines personal data by entering:
a. name(s)
b. An unlimited number of addresses for preferred starting/ending point locations and naming each of them (e.g. “Home”, Work”, “XYZ Corporation”, “Hilton Hotel”) including street address, city, zip code, phone, country and phone.
c. Credit card information including card number, CSV, expiration date and billing address if different than the home or work address.
2. An unlimited number of airline and/or other transportation or accommodation providers' membership numbers:
   a. frequent flyer number for airlines
   b. frequent guest number for hotels and hotel chains
   c. frequent traveler number for car rentals or other transportation providers
   d. Personal identification numbers (PIN) for the memberships
3. Passport information:
   a. Citizenship(s)
   b. Passport Number(s), dates of issue and expiration date
   c. Place of birth

If the traveler is a pre-existing user or previously registered user of trip planner 20, the person signing in may simply enter a username and password or other authorization information, wherein trip planner 20 retrieves the identifying an account information from stored records. As part of the sign in process, the traveler may further be asked whether he or she wishes a previous stored profile to be used for the secondary criteria or whether such previously stored record should be updated. The user or traveler may further be asked whether he or she wishes to use a stored template of a previous trip. As indicated by step 412, input element 22 further requests that the traveler input the above-described base parameters or base criteria. The traveler is asked to enter (using a keyboard, mouse or other input device) a range of departure dates from an origin location and a range of arrival dates at a destination location. A range may constitute a single day or even a restricted time range during a single day. As noted above, the entered base criteria is transmitted to and used by search element 24.

For example, in one embodiment, the base criteria may be received and processed in the following manner.
The traveler may be asked to choose between different trip options.
   One way
   Round trip
   Multiple segments
   Flexibility in dates of travel
Graphical User Interface (GUI) to choose between two or more predetermined points stored in the user profile.
GUI to choose between one or more predetermined points stored in the user profile and one or more points specified by typing in a specific address (123 Main Street, Anywhere, WI, 53200 USA), location name (Holiday Inn Stockholm, Sweden) or any combination thereof, providing the user inputs a country name in addition to at least one other location identifier, such as zip code, city name, etc.
The location or address is then checked by the GIS system to ensure validity. In the event the GIS system cannot locate the specific address, it will automatically check for validity of the city or zip code. In the event the city/zip code cannot be verified, a list of possible matches within the specified country will be displayed from which the user may choose the most applicable one.
The correction mode of the GIS system within the search GUI will repeat until all stops in the trip have been identified and verified by both the GIS and the user on an address level or a city level or a zip code level.
Once all stops have been identified and verified, the user inputs the applicable trip parameters for each segment to include a departure date and time or—for goal-oriented trips—a specified arrival time for a reverse search.
Desired level of restrictions on the different modes of transportation.
   As a result, every verified address the location may be stored by trip planner 20 for future use by others for faster searches.

As indicated by step 414, search element 24 identifies, from an initial universe of trips, all trips that satisfy the entered base criteria. The universe of trips that are initially searched are provided by trip source 26. As indicated by step 416, trip source 26 searches various mode schedules 34 (shown in FIG. 1) and formulates trips. As noted above, process 400 may additionally include the creation of specialized mode schedules or mode databases providing schedules for modes of transportation, wherein such schedules may not otherwise be commercially available. As indicated by step 418, trip source 26 may additionally use the results from the searching of mode schedules to create or update/maintain a search database from which the universe of trips for searching is provided to search element 24. The search database may be created or updated prior to any of steps 410, 412 or 414. As indicated by step 420, trip source 26 accesses the created database and provides trips from the database to search element 24 for filtering using the base criteria.

Based upon the input origin location and destination location, search element 24 determines the nearest transportation node (terminal origin) prior to searching for a trip or route. In particular, an external geographic information system (GIS) of search element 24 uses LAT/LON information associated with the inputted address or location and combines that information with similar LAT/LON information for transportation nodes (starting and ending points for particular modes of transportation) in order to find the nearest one(s) to the address or location, within a pre-specified distance.

Further, a weighting system is used for determining convenience of use of a mode or node in order to make use of it as it relates to factors of time, number of connections and cost (e.g. greater penalties are given to more connections needed to get from a bus stop to the airport while the train station has non-stop service).
1. Each trip search is broken down into segments (e.g. Milwaukee to London is segment 1, London to Milwaukee is segment 2)
2. Each segment is broken down into sub-segments (address in Milwaukee to airport is sub-segment 1, airport to airport is sub-segment 2, airport to address in London is sub-segment 3)
3. Each sub-segment is broken down to modes of transportation (train to air to shuttle).

For those trips that may include overnight accommodations, the GIS (Geographic Information System) will determine the nearest accommodations to a destination address or location. The secondary criteria from the user profile narrows the search for hotel accommodations only to those that are within the parameters set by the user. The GIS provides the data for nearest properties to the destination address according to two methods:
A property entered by the user as the final destination of a segment
A list of proximate properties displayed on a map, within a given distance of the address or location.

Each hotel listing is set with an arrow or other form of displaying the location on the map. A short summary of the hotel name, hotel rating and room rate ranges for the entire stay are displayed. Should the user choose a hotel using the computer mouse (click) to hover over the property name, a larger window appears showing pictures and a greater description of the hotel and the room types, from which the user may choose a room type.

According to one embodiment, trip source 26 utilizes a series of interfaces (such as XML) with transportation providers that supply their scheduling data via such connectivity (rather than through raw data which is stored in an internal database). Information is retrieved from these sources in different formats (such as SSIM—Standard Schedule Information in one embodiment, trip source 26 retrieves following scheduling information.

Scheduled Airlines: airline name and IATA code, flight number, country of departure (full name and international 2-letter code), city of departure (full name and IATA code if applicable), airport of departure (full name and IATA code), geographic reference (Lat/Lon, address, zip code, phone), aircraft type, local time of departure, local time of arrival, country of arrival (full name and international 2-letter code), city of arrival (full name and IATA code) airport of arrival (full name and IATA code), geographic reference (Lat/Lon, address, zip code, phone), GMT offset for arrival and departure airports, days of the week flight is operated, start and end dates for seasonality, flight length in miles, flight length in time, number of intermediary stops (for non-direct flights), countries of intermediary stops (full name and international 2-letter code), cities of intermediary stops (full name and IATA code if applicable), airports of intermediary stops (full name and IATA code), geographic reference (Lat/Lon, address, zip code, phone), local time of arrival for each stop, local time of departure for each stop, GMT offset for each stop, international or domestic distinction, frequent traveler affiliation.

Non-scheduled Airlines: (e.g. air taxi, chartered aircraft) airline name and IATA code or tail number, flight number (if applicable), chartering company name, country of departure (full name and international 2-letter code), city of departure (full name and IATA code if applicable), airport of departure (full name and IATA code), geographic reference (Lat/Lon, address, zip code, phone), aircraft type, local time of departure, local time of arrival, country of arrival (full name and international 2-letter code), city of arrival (full name and IATA code) airport of arrival (full name and IATA code), geographic reference (Lat/Lon, address, zip code, phone), GMT offset for arrival and departure airports, flight length in miles, flight length in time. number of intermediary stops (for non-direct flights), countries of intermediary stops (full name and international 2-letter code), cities of intermediary stops (full name and IATA code if applicable), airports of intermediary stops (full name and IATA code), geographic reference (Lat/Lon, address, zip code, phone), local time of arrival for each stop, local time of departure for each stop, GMT offset for each stop, international or domestic distinction, frequent traveler affiliation.

Rail: rail company name and IATA code (if applicable), train number, country of departure (full name and international 2-letter code), city of departure (full name and IATA code if applicable), station of departure (full name and IATA code or station ID), geographic reference (Lat/Lon, address, zip code, phone), train type (local, national, underground), local time of departure, local time of arrival, country of arrival (full name and international 2-letter code), city of arrival (full name and IATA code) station of arrival (full name and IATA code or station ID), geographic reference (Lat/Lon, address, zip code, phone), GMT offset for arrival and departure stations, days of the week train route is operated, start and end date for seasonality, trip length in miles, trip length in time, international or domestic distinction, frequent traveler affiliation.

Ferries/Cruise Ships: Ferry/cruise company name and IATA code (if applicable), ferry/cruise number, country of departure (full name and international 2-letter code), city of departure (full name and IATA code if applicable), port of departure (full name and IATA code), geographic reference (Lat/Lon, address, zip code, phone), ferry/cruise type (local, national), local time of departure, local time of arrival, country of arrival (full name and international 2-letter code), city of arrival (full name and IATA code), port of arrival (full name and IATA code), geographic reference (Lat/Lon, address, zip code, phone), GMT offset for arrival and departure ports, days of the week route is operated, start and end date for seasonality, trip length in miles, trip length in time, international or domestic distinction, frequent traveler affiliation.

Bus: Bus company name, route number, country of departure (full name and international 2-letter code), city of departure (full name and IATA code if applicable), station of departure (full name and IATA code if applicable or station ID), geographic reference (Lat/Lon, address, zip code, phone), bus type (local, national), local time of departure, local time of arrival, country of arrival (full name and international 2-letter code), city of arrival (full name and IATA code), station of arrival (full name and IATA code if applicable or station ID), geographic reference (Lat/Lon, address, zip code, phone), GMT offset for arrival and departure stations, days of the week bus route is operated, start and end date for seasonality, trip length in miles, trip length in time, international or domestic distinction, frequent traveler affiliation.

Scheduled Shuttles: Shuttle company name, country of departure (full name and international 2-letter code), city of departure (full name and IATA code if applicable), station of departure (full name and IATA code if applicable), geographic reference (Lat/Lon, address, zip code, phone), local time of departure, local time of arrival, country of arrival (full name and international 2-letter code), city of arrival (full name and IATA code if applicable), station of arrival (full name and IATA code if applicable), geographic reference (Lat/Lon, address, zip code, phone), GMT offset for arrival and departure stations, days of the week shuttle route is operated, start and end date for seasonality, trip length in miles, trip length in time, frequent traveler affiliation.

Non-Scheduled Shuttles/Limousines/Taxi: Company name, country of departure (full name and international 2-letter code), city of departure (full name and IATA code if applicable), station of departure (full name and IATA code if applicable), geographic reference (Lat/Lon, address, zip code, phone), local time of departure, local time of arrival, country of arrival (full name and international 2-letter code), city of arrival (full name and IATA code if applicable), station of arrival (full name and IATA code if applicable), geographic reference (Lat/Lon, address, zip code, phone), GMT offset for arrival and departure stations, trip length in miles, trip length in time, frequent traveler affiliation.

In embodiments where trip source 26 creates and updates an internal database of available trips, trip source 26 may include a data parser designed to read the data from each of these interfaces, convert it to the type of data fields required in the internal databases and store the data in an internal database.

In formulating trips from the mode schedules, trip source 26 further takes into account minimum connecting times between different modes of travel as well as between different segments using the same mode of transportation. In one embodiment, trip source 26 utilizes a data base including actual or estimated MCT data for every transportation hub (node are connecting point between consecutive trip segments). According to one embodiment, the data is broken down to the following information for each segment:
Transportation providers (e.g. British Airways or Japan Rail)—Each provider is one mode.
International or domestic
Same or different terminals
Same or different hubs (e.g. JFK and LaGuardia in New York or JFK and Penn Station)
Same or different modes of transportation (Air to Air, Air to Rail, etc).

MCT database holds the following information for each hub for MCT minutes required:
Same provider, same terminal, domestic to domestic, MCT minutes required
Same provider, same terminal, domestic to international, MCT minutes required
Same provider, same terminal, international to international, MCT minutes required
Same provider, same terminal, international to domestic, MCT minutes required
Same provider, different terminals, domestic to domestic, MCT minutes required
Same provider, different terminals, domestic to international, MCT minutes required
Same provider, different terminals, international to domestic, MCT minutes required
Same provider, different terminals, international to international, MCT minutes required
Same provider, different hubs, domestic to domestic, MCT minutes required
Same provider, different hubs, domestic to international, MCT minutes required
Same provider, different hubs, international to domestic, MCT minutes required
Same provider, different hubs, international to international, MCT minutes required
Different providers, same terminal, domestic to domestic, MCT minutes required
Different providers, same terminal, domestic to international, MCT minutes required
Different providers, same terminal, international to international, MCT minutes required
Different providers, same terminal, international to domestic, MCT minutes required
Different providers, different terminals, domestic to domestic, MCT minutes required
Different providers, different terminals, domestic to international, MCT minutes required
Different providers, different terminals, international to domestic, MCT minutes required
Different providers, different terminals, international to international, MCT minutes required
Different providers, different hubs, domestic to domestic, MCT minutes required
Different providers, different hubs, domestic to international, MCT minutes required
Different providers, different hubs, international to domestic, MCT minutes required
Different providers, different hubs, international to international, MCT minutes required

In addition, trip source 28 also takes into account minimum check-in times for each mode of transportation. In one embodiment, trip source 26 utilizes an internal database regarding the minimum check-in time for each mode of transportation and for each provider within that mode. Additionally, data stored contains the estimated exit time at the end of the segment used by the mode or specific provider.

As indicated by step 422, the results of the base criteria filter performed by search element 24 are then forwarded to filtering element 28 (shown in FIG. 1). Filtering element 28 additionally filters such trips so as to remove from further consideration those trips that do not satisfy secondary criteria. As noted above, in one embodiment, the initial secondary criteria applied by filter element 28 is availability, those trips for which every element or aspect of the trip, which satisfies the base criteria, is available for selection. In other words, a trip is available if there are available seats on each of the modes of transportation during the various segments of the trip or there are available rooms or beds at overnight accommodations when two consecutive segments are joined by an overnight stay at a hotel or motel accommodation. In other embodiments, availability may be applied as a base criteria instead of as a secondary criteria depending upon the information stored in the database created by trip source 26. For example, in some embodiments, trip source 26 may create the database such that only available to us are stored in the database, wherein trips may be removed from the database during updates as they become no longer available.

As part of step 422, filtering element 28 uses user preference secondary criteria to further filters those trips that initially satisfied the base criteria and that are available. As indicated by step 424, method 400 includes requesting and receiving the secondary criteria. As noted above, input element 22 instructs a processor or computing device to control a display or other output device to request input of the secondary criteria. A non-exhaustive list of secondary criteria is identified in block 426. In step 424, secondary criteria is directly entered and forwarded to filter element 28 for carrying out step 422 each individual time a search is made. As indicated by step 428, secondary criteria may alternatively be provided to filtering element 28 from a stored traveler profile as described above and an example of which is shown in FIG. 2. In certain embodiments, a traveler may have multiple profiles available for use for different travel situations, wherein the traveler indicates during the sign in step 410 which of the profiles are to be used. As noted above, in some embodiments, the secondary criteria used by filtering element 28 in step 422 may be received from both a traveler profile and direct input of secondary criteria during a particular search by a traveler using one or more input devices.

According to one embodiment, input element 22 causes a processor to direct a display to prompt a user or traveler to input his or her travel preferences which serve as secondary criteria by:
i. answering all or some of a series of questions about the user's travel preferences as they relate to modes of transportation.
ii. answering all or some of a series of questions about the user's travel preferences as they relate to fares.
iii. Answering all or some of a series of questions about the user's preferences as to meals, seating assignments and other general preferences.
iv. answering all or some of a series of questions about the user's perceived monetary values for travel time, extra connections, usage of bonus tickets or other services.
v. Answering all or some of a series of questions about preferred class of service on specific transportation modes and/or according to the trip elapsed time.
vi. Answering all or some of a series of questions about hotel accommodations, including:
   1. Preferred amenities (such as pool, wireless internet, etc.)
   2. Preferred hotel chains
   3. Preferred room types (non-smoking, two double beds)
   4. Perceived monetary value for using bonus hotel stays (from points)
vii. Preferred currency for viewing search results
viii. Use of value of non-refundable tickets (Y/N).

One example of entry of information to form a traveler profile would be as follows. A traveler may predetermine parameters where she has a FF account with Delta Airlines and PREFERS to fly with Delta Airlines or their FF partners unless the price of a competitor is at least 10% less than that of Delta or its partners; she may further predetermine that she NEVER wants to travel by bus or by turboprop aircraft; she may further predetermine that she PREFERS non-stop transportation between nodes, unless the cost of connecting through an intermediary hub is at least $100 per hour of transit less than the cost of a non-stop mode. Finally, she may further predetermine that her FF account with Delta airlines only be used for a free ticket on a segment (s) if the cost of that segment(s) is more than $500.

One secondary criteria applied by filtering element 28 may be price. In other words, those trips falling outside of a particular price range or those trips having particular trip segments which individually fall outside a predefined price range for a trip segment between two specific locations may be removed for further consideration. To determine pricing for trips, filtering element 28 may cause a processor or server to communicate with one or more databases. A series of continuously updated databases storing the price in local currency for each supplier for each segment of a trip, may include the following information:
Price for one way from point A to point B
Price for round trip from point A to point B to point A
Price for travel during a specific time period
Price for travel on a number of trips
Price for travel by distance
Price for travel by total time of travel
Each of the above categories is further broken down to the following sub categories:
   Price according to seasonality with start and end dates for seasons
   Price according to days of the week
   Price according to time of day of travel
   Price according to number of passengers in the party
   Price according to passenger type (age, student, military, government, corporate)
   Price according to negotiated contract between supplier and traveler or third party
   Applicable Taxes
   Applicable surcharges

In one embodiment, filtering element 28 may employ a series of XML API's connected to a GDS (Global Distribution System) and to transportation providers that supply their pricing data through such connectivity (rather than through raw data which is stored in an internal database).

Examples of sources for pricing including internal sources and external sources.
a. Internal sources: A series of databases holding prices for single or multiple segments of travel on specific transportation providers. These transportation providers are availability-independent to offer a price for the service and their prices are usually constant or predictable. Examples of these include:
   i. Local rail
   ii. Airport shuttle services
   iii. Bus companies
   iv. Limousine companies
   v. Some private and chartered jets
   vi. Ferries
   vii. Free services (such as hotel shuttles or shuttles provided by airlines)
b. External sources: A series of interfaces with external sources for pricing on single or multiple segments of travel on a specific transportation provider or a combination of providers on several segments. These providers are availability-dependent, requiring inventory in a specific category (class) to be available in order to provide the correct prices. Examples of these include:
   i. One or more links to a GDS for legacy carriers
   ii. Links to participating legacy carriers for FF availability
   iii. Links to low cost carriers for standard and FF availability
   iv. Links to rail companies
   v. Links to third party pricing suppliers for global and local faring
   vi. Links to consolidators
   vii. Links to applicable hotels used for Hotel As Segment.

According to one embodiment, pricing is calculated in several steps:
1. Best route according to secondary criteria is stored and sent for pricing request as below.
2. Unbundling all availability-independent providers so they are priced as stand-alone products (where more than one provider is part of the route).
   a. Each availability-independent provider is priced according to the prices stored in the respective database for that provider.
   b. According to the number of segments for each provider, the pricing for each segment of each provider is determined according to the parameters set forth in the internal pricing sources
      i. Price for one way from point A to point B
      ii. Price for round trip from point A to point B to point A
      iii. Price for travel during a specific time period
      iv. Price for travel on a number of trips
      v. Price for travel by distance
      vi. Price for travel by total time of travel
      vii. Each of the above categories is further broken down to the following sub categories:
         1. Price according to seasonality with start and end dates for seasons
         2. Price according to days of the week
         3. Price according to time of day of travel
         4. Price according to number of passengers in the party
         5. Price according to passenger type (age, student, military, government, corporate)
         6. Price according to negotiated contract between supplier and traveler or third party
         7. Applicable Taxes
         8. Applicable surcharges
         9. Applicable fees such as baggage fees, carry-on fees, for any particular provider.
3. The prices for each provider are converted if necessary from the local currency to the currency preferred by the user as predefined by the user.
4. The relevant information is stored in a pricing area.
5. Unbundling all availability-dependent transportation providers so they are priced as stand-alone products (where more than one provider is part of the route).
   a. Each availability-dependent provider is priced by sending out an availability and pricing request to the applicable interface, such as the GDS or interface directly with the provider.
   b. According to the number of segments for each provider or all providers as a whole, the pricing for each segment is determined according to the parameters set forth by the provider through the GDS or directly through the interface.
      i. Price for one way from point A to point B
      ii. Price for round trip from point A to point B to point A
      iii. Price for multiple segments operated by more than one availability-dependent provider
      iv. Price as a pass (for several segments operated by one provider within a certain region)
      v. Price using a progressive method whereby a trip from A to B to A can be defined as tickets, whereby
         1. O,D=Origin and Destination of segment (for availability-dependent segments only)
         2. H=Intermediary hub for connection between O & D
         3. P1, P2=Separate providers
         4. T1, T2=Ticket number(s)
         5. Thereby producing the following pricing options for a sample one way ticket:
         a. O>T1/P1>D (Origin using to provider 1 to Destination)
         b. O>T1/P1>H1>T1/P1>D
         c. O>T1/P1>H1>T1/P2>D
         d. O>T1/P1>H1>T2/P2>D
         6. The process is repeated for all availability-dependent segments. As an example of this process, a one way ticket from New York to Moscow. The sample possibilities are as follows:
         a. One ticket on Delta Airlines, non-stop New York to Moscow.
         b. One ticket on Delta Airlines, New York to Atlanta to Moscow.
         c. One ticket issued on Delta Airlines stock for travel New York to Paris on Delta and then Paris to Moscow on Air France.
         d. One ticket on Delta Airlines from New York to Paris and a second ticket on Air France from Paris to Moscow.
      vi. Price for travel during a specific time period
      vii. Price for travel on a number of segments with the same provider (e.g. Rail pass)
      viii. Price for travel by distance (e.g. air passes)
      ix. Price for travel by total time of travel
      x. Each of the above categories is further broken down to the following sub categories:
         1. Price according to seasonality with start and end dates for seasons
         2. Price according to days of the week
         3. Price according to time of day of travel
         4. Price according to number of passengers in the party
         5. Price according to passenger type (age, student, military, government, corporate)
         6. Price according to negotiated contract between supplier and traveler or third party
         7. Applicable Taxes
         8. Applicable surcharges
         9. Applicable fees such as baggage fees, carry-on fees, for any particular provider.
6. The prices for each provider are converted if necessary from the local currency to the currency preferred by the user as predefined by the user.
7. Any remaining value from unused non-refundable tickets is calculated in an applicable journey on the same carrier, less any penalties for changes.
8. The relevant information is stored in a pricing area.
9. The prices are totaled in the user-defined currency and stored in an itinerary-price record for display and future use by the user or an administrator.

As noted above, travel between a remote origin and a terminal origin may be achieved using the traveler's own vehicle rather than a shuttle, taxi, limousine or other transportation mode. When analyzing the pricing of this transportation mode, filtering element 28 may assign a price to the segment using the governmental standard for mileage reimbursement (which takes into account vehicle wear and fuel or energy consumption), the distance between the remote origin and the terminal origin, the daily parking rate at the terminal origin in the number of days that the traveler's vehicle will need to be parked. In this way, filtering element 28 may compare different trips wherein the traveler may either travel to the airport using a shuttle or limousine service or alternatively use his or her own vehicle and park in their own vehicle at the terminal destination. Depending upon the number of days of travel and the parking rate at the terminal origin, the most cost-effective choice may vary.

As indicated by step 430, output element 30 of trip planner 20 presents or outputs the results of the filtering steps carried out by search element 24 and filtering element 28. As noted above, output 30 (shown in FIG. 1) visibly and/or audibly presents to a traveler the trips that remain after filter element 28 has removed those additional trips that, although satisfying the base criteria and although being available, still do not satisfy one or more traveler preference secondary criteria. In one embodiment, output 30 may present only those trips that satisfy all secondary criteria. In one embodiment, output 30 may present the remaining trips in the order of cost and least expensive to most expensive or vice versa. In one embodiment, output 30 is configured to additionally list trips that satisfy most of the secondary criteria, but which may fail some criteria. By doing so, output 30 enables the traveler to reconsider or compromise on the importance of some of the secondary criteria given potential cost savings. For example, in one embodiment, input element 22 may be configured to prompt a traveler using planner 20 to identify a maximum number of preferences that need not necessarily be satisfied by an available trip for the available trip to still be displayed for potential selection. In yet another embodiment, input element 22 may be configured to prompt the traveler using planner 20 to weigh or prioritize the importance of each of the secondary criteria as the traveler enters the secondary criteria. In such an embodiment, those available trips that only fail less important secondary criteria may still be presented by output 30 as a trip available for selection. In embodiments where no single trip satisfies each and every traveler preference secondary criteria, output 30 may be configured to list available trips in order of the percentage of secondary criteria that are satisfied by each trip. In one embodiment, output 30 may be configured to present a maximum number or a minimum number of trips for selection. In such an embodiment, input element 22 may be configured to prompt a traveler for a maximum number or minimum number of trips that should be displayed regardless of how many trips actually satisfy all of the secondary criteria or how may trips even satisfy any of the secondary criteria. In presenting the trips available for selection, output element 30 may additionally order the selectable trips in order of cost. As noted above, in other embodiments, such trips may alternatively be listed based upon the degree to which the trips satisfied the secondary criteria.

According to one embodiment, the search results are displayed on the screen for the user, through a dynamic, color-coded graphical user interface (GUI).
a. The most appropriate search results for each segment of the trip are displayed on a screen (a segment is defined as start point to end point of a portion of a trip, including all modes of transportation used to get from start to end of the segment).
b. All availability-dependent providers which are displayed as an option are sent for an availability request and price quote by the provider. The price quote is calculated as part of the whole trip. Seats for the applicable prices are held in interim (SS status) while the user searches the options. Once a specific option is chosen by the user, all unneeded availability-dependent seats are released.
c. The search results are displayed in order of applicability to the user's predefined preferences, price, trip length and overall match-score according to weights used in the traveler's profile. Color codes allow for quick reference.
d. Each result option for each segment displays:
   i. Itinerary details for the option
   ii. Over all price of the trip if the particular option be selected.
   iii. Number of FF points to be gained by using a particular provider
   iv. Number of FF points paid to the provider for the segment
   v. Penalties for changes, cancellations and other pertinent information
e. Hotel as a segment is displayed the same as a travel segment
f. As the user displays the options for each segment, relevant travel requirements are displayed in flashing color to inform the user should the need arise to extend the passport validity, obtain a visa or get inoculated. This information is streamlined into the segments and is obtained when comparing the user's profile information and the database or other source of passport and inoculations information
   i. Should any action be required by the user, a link will be displayed to the appropriate form that needs to be filled out and will be pre-populated (where possible) with the users information as entered in the profile.
   ii. Further information will be displayed as to where the form(s) needs to be sent and the costs.
   iii. The user can print the form either as a blank form or pre-populated in order to send it to the appropriate location.
g. The user chooses between the most appropriate options for each segment by saving the segment to the trip itinerary and continuing on to the next page for the next segment.
h. Once all segments have been confirmed by the user, the trip is stored for the maximum time allowed by the most time-restrictive provider in the itinerary (such as advance purchase requirements). The user may opt to store the trip and return to it according to the advance purchase requirements, or purchase the trip.

As indicated by step 432, trip planner 20 further prompts the traveler or potential traveler to input his or her selected trip. This can be done in any of them all to do different fashions such as by checking a box next to the selected trip, by highlighting the selected trip, by entering the name or identification number of the selected trip in a selection box and the like.

As indicated by step 434, output 30 further prompts the traveler as to whether trip planner 20 should proceed with booking or reserving seats and accommodations for the trip. In the example illustrated, trip planner 20 requests that the traveler identify which segments that the traveler desires trip planner 20 to book and which segments that the traveler 20 desires to personally book himself or herself. In yet other embodiments, output 30 may automatically book all segments and all accommodations via the Internet or by other communication.

As indicated by step 436, if the traveler indicates that trip planner 20 is to book one of more segments of the selected trip, output 30 further instructs a computing device or processor to cause the display to prompt the traveler to input payment information and an address to which travel receipts or vouchers should be sent. Such travel vouchers may be sent by mail or electronically such as through an e-mail. In some embodiments, travel vouchers may simply be printed out by the traveler from the website providing travel planner 20. As a result, trip planner 20 further simplifies the making of travel arrangements by facilitating the booking of travel for different transportation modes associated with different segments of a trip and the acceptance of a single payment for different transportation modes or four the same transportation mode, but with different carriers. The single payment may also cover the cost of any overnight accommodations for the selected trip.

According to one embodiment, once the selected segments, accommodations and transportation providers have been confirmed by the user or traveler, reservations and payments are administered as follows:
1. Reservations:
   a. Availability-independent transportation providers require no reservation.
   b. Availability-dependent providers:
      i. A PNR (Passenger Name Record) is created in the applicable GDS system with information from the passenger profile, including credit card information. Seat requests other pertinent information is transferred as well.
      ii. If any or all of the availability-dependent segments are issued against the users FF account with that provider, those reservations are made directly through the link with the provider, since most of them do not have this availability shown through the GDS.
      iii. A purchase request is sent to the provider and the ticket is issued.
   c. Information from the availability-dependent supplier and the user profile is used to create an internal PNR with a reference number into which the entire itinerary, including all types of segments and confirmation numbers, are copied.
   d. The internal PNR displays all relevant information about the trip and offers other capabilities such as changes, cancellations, emailing the itinerary or saving the trip as a template for future trips.
2. Once a purchase has been made on an availability-dependent provider (usually an airline), a 13-digit (or more digits) serial number is generated for the ticket as is with all airline and rail tickets that are sold via IATA agencies.
   a. This ticket number is the basis for all financial transactions relating to all availability-independent and availability-dependent suppliers relating to each segment, so that future reconciliation with suppliers is numbered.
   b. Any provider that usually does so will charge the user's credit card.
   c. Alternatively, the user's credit card will be charged internally for all providers that do not accept credit cards or prefer to be paid by the company on a periodical basis.
3. A copy of every ticket issued within a trip is sent to the client via email or mobile phone.

According to one embodiment, payment follows the following The 13-digit IATA ticket number issued by the initial availability-dependent provider on every (or all) segment(s) becomes the serial number and financial tracking basis for moving the payments and reconciling between the user and all providers for that segment.

The user pays in three ways:
1. Immediate payment to the provider as is the case with airline tickets.
2. Immediate payment to the travel company which then disperses the money to other sources.
3. Guarantee payment with a credit card (such as the case with hotels) and payment sometime before travel or immediately thereafter.

For all availability-independent providers (such as shuttles, bus companies, etc.), the system works whereby the serial number is printed on a payment voucher (ticket) or transmitted to the user by electronic mail or to a Fax device or through the company website or through a mobile device which is then used by the user to show payment has been made prior to boarding the provider. The provider collects the vouchers or scans the bar code and bills the travel company for all vouchers. Each voucher (which is essentially a ticket) is also marked with a bar code for the ticket number, a bar code which can be displayed on paper, on a mobile device or other screens and read by any provider, including the airlines. In other words, the boarding pass for the flight also becomes the boarding pass for the shuttle and the ticket for the train.

Overall, method 400 performs, in one seamless transaction, door-to-door intermodal transportation searches, taking into account multiple fare level possibilities, travel requirements (passport, visa, health) and traveler preferences which may or may not be waded such that the most appropriate results are displayed. Although trip planner 20 and method 400 have been described for providing destination oriented travel (specific travel from an origin location to a destination location), trip planner 20 and method 400 may also provide goal and target oriented travel. For example, in one embodiment, information is stored internally or collected externally about certain events or attractions to which travelers often go. These include, but are not limited to:
1. Cruises (including embarkation and disembarkation dates, times and ports)
2. Fair, conventions and congresses
3. Tourism events
4. Personal events stored by the user (wedding, meeting, etc.)

The information is stored internally (by the company or the user) or collected externally including:
1. Exact start and end locations
2. Start and end dates and times

Once the traveler chooses an event and predetermines the number of days (if any) to arrive prior to—, or depart after the event, the system can create a “reverse search” which displays an itinerary created specifically to arrive to, and depart from, the event according to the set times. A standard timeframe for “before and after” windows is preset according to the user or by default.

In yet another embodiment, trip planner 20 and method 400 may alternatively search for a trip based on weather, activities, price or all, inputting the required dates and specifying other information for the search algorithm. The user predefines any of a number of parameters and allows the system to search for the most appropriate trip according to those parameters. As an example, a user may search for travel according to the following criteria:
1. 2 Adults and 3 Children ages 14, 11 and 8
2. Travel using maximum FF points for airlines and hotels
3. Travel to destinations that are:
   a. not more than 8 hours of total trip time in either direction.
   b. where the weather is expected to be over 80 degrees.
   c. Offer airport shuttles
4. Maximum $3000 total cost

The system of trip planner 20 will then work by eliminating any place where the temperature is under around 80 degrees or that the travel time is greater than 8 hours in each direction. Trip planner 20 may access and collect external temperature and other global weather data (such as from www.weather.com).

Searching is performed specifically for seat inventory available for use with FF bonus on flights or room inventory available with FG bonus.

Once this information is determined by narrowing the search with each parameter, the total cost according to availability is determined and any package with a cost of over around $3000 is eliminated as well.

The remaining options are displayed with pre-populated search results showing the itineraries and costs from which the user may chose and begin the process as would be done for a normal reservation described above.

For any trip that is presented by output 30 or that is selected by a traveler, trip planner 20 may store the itinerary in a memory as a template for future travel. The template or shell is stored in the profile. Upon being recalled by the user or traveler, trip planner 20 searches for pricing and availability as described above. If acceptable, the trip may be booked or reserved. As a result, repeat trips may be more easily and quickly retrieved and searched.

FIG. 6 schematically illustrates trip planning system 500. Trip planning system 500 is configured to carry out method 400 or similar methods following the instructions of trip planner 20. Trip planning system 500 includes computing device 502, server 502, computing device 504, user profile database 32, trip database 36 and availability and pricing sources are databases 506, 508. Server 502 comprises a network or Internet server including trip planner 20. Server 502 provides an Internet site which may be accessed by one or more computing devices 504. Server 502 includes one or more processing units configured to carry out instructions provided by the computer program embodying trip planner 20. Server 502 is further configured to receive input from computing device 504 and to provide output to computing device 504.

Computing device 504 comprises a terminal, or other device configured to connect to server 502 through a network or the Internet. Computing device 504 includes an output display 510 and an input device 512. Display 510 and input device 512 (shown as a keyboard) enable a user or traveler to provide server 502 with personal information, base criteria (search parameters) and secondary criteria (travel preferences). As shown by FIG. 6, display 510 also permits a completed itinerary to be presented to the user. In such an embodiment, input device 512 further enables the traveler or user to select one of the presented trips for booking. Although computing device 504 is illustrated as a computer monitor and keyboard, another embodiment, computing device 504 the alternatively comprise any Internet accessing device such as a personal data assistant, cell phone, IPOD and the like.

Traveler or user profile database 32 and trip database 36 Rh described above. In one embodiment, database 32 and 36 may be stored on memory correctly associated with server 502. In other embodiments, database and 32 and 36 may be at remote storage sites. In some embodiments, the user profile 32 may be stored on memory associated with the computing device 504, were in the profile is uploaded when a particular person at the computing device 504 wishes to conduct a search.

Pricing and availability sources 506, 508 comprise sources of information utilized by trip planner 20 and server 502 to complete a search. Source 506 provides availability and pricing information for such travel modes as air and rail. Source 506 further provides pricing information using GDS. Source 508 provides availability for other travel mode suppliers which are not commercially available through such data suppliers and pricing information for other travel mode suppliers which are not commercially available through GDS.

FIG. 7 is a flow diagram illustrating method 600, a particular example of method 400 described above, that may be carried out by system 500. As indicated by step 602, system 500 initially prompts the user to indicate whether or not he or she is an existing subscriber or member to system 500. If the user is an existing member or subscriber, system 500 checks to see whether a particular user has a profile or set of secondary preferences stored in storage 605 as indicated by step 604. If the profile indicates that the person has frequent flyer accounts or other bonus accounts, system 500 retrieves and stores current balances of such trip and flyer or other bonus accounts in internal storage 608 as indicated by step 606.

As indicated by step 610, system 500 further prompts the user as to whether he or she wishes to use a prior to that trip or template. As indicated by step 612, if the existing member indicates that he or she does not wish to use a prior trip or template or if the user indicates that he or she is not an existing member in step 602, some 500 prompts the user to input his or her trip request. In other words, system 500 prompts the user or traveler to input the above-described base criteria.

As indicated by steps 614, search element 24 of system 500 identifies starting and ending points for modes of transportation within predetermined acceptable distances from the origin location and the destination location entered as base criteria.

As indicated by step 618, trip source 26 accesses a commercial scheduled database 620 for schedules for rail and air modes of transportation. Trip source 26 accesses non-scheduled databases 622 for schedules for modes of transportation which are not available in the commercial scheduled database 620. Using such information, trip source 26 establishes or update database 36 (shown in FIGS. 1 and 6).

FIG. 7A further illustrates one example process or algorithm that may be carried out by trip source 26 to form trip database 36. Overall, the search algorithm orders or ranks all possible or available itineraries or trips between two locations based upon the time required for each trip and the number of intermediate locations or stops for each trip (preliminary criteria). In one embodiment, only a certain top percentage or a number of top ranked trips are saved in the database. Those possible trips outside the top percentage or top number of trips are discarded. As a result, data base 36 is more manageable.

In one embodiment, trip source 26 carries out the algorithm once and then updates those trips having sufficiently high ranks that form the database 36. In another embodiment, trip source 26 carries out the algorithm repeatedly on a periodic basis or in response to a request. In one embodiment, trip source carries out the algorithm for some pairs of locations (trips) more frequently than other pairs of locations. In other embodiments trip server 26 carries out the algorithm at the same frequency for all pairs of locations (origin and destination).

In one embodiment, trip source 36 may save only the top 1000 trips or the top 60 percent of all trips between two particular locations. The same percentage or number of trips is saved for each and every combination of origin and destination locations. In other embodiments, trip source 26 may alternatively save different numbers or different top percentages of trips such as only the top 500 trips or top 25% of all trips between each pair of locations. In some embodiments, trip source 26 may save or store a different number or different percentage of trips between a first pair of locations as compared to a second pair of locations. For example, trip source 26 may save or store the top 50% of trips between Milwaukee and Beijing while storing or saving only the top 30% of possible trips between Milwaukee and Miami.

In other embodiments, different preliminary criteria may be applied by trip source 26. Other preliminary criteria include, but are not limited to, maximum total trip layover time, maximum individual layover time, total maximum individual trip segment time, minimum individual trip segment time and the like. Moreover, in other embodiments, rather than saving or storing trips based upon their ranking (numerical or percentile), trip source 26 may save or store trips based upon other thresholds. For example, in other embodiments, rather than saving or storing the top percentage of trips of the top number of trips, trip source 26 may store save only the trips that have a total travel time falling below a predetermined time or that have a total number of stops falling below a predetermined maximum number of stops.

According to one embodiment, trip source 28 creates the database 36 in the form of a graph or series of graphs. For purposes of this disclosure, the term “graph” refers to mathematical structures used to model pair-wise relationships between objects from a certain collection. A graph is a collection of vertices or nodes and a collection of edges that connect the pair of vertices. (See Biggs, N.; Lloyd, E. And Wilson, R. Graph Theory, 1736-1936 (1986) Oxford Unviersity Press, incorporated by reference). According to one embodiment, the search algorithm carried out by trips source 26 is a shortest-path algorithm, which is a greedy algorithm that uses a priority queue. In the context of this algorithm, “shortest” means that the path that is finally found by the algorithm has the lowest total weight. Essentially, the shortest-path algorithm is an iteration of the breadth-first search algorithm that starts at one vertex in a network of vertices and stops as soon as the pair corresponding to the destination vertex is removed from the priority queue. Each of the pairs in the priority queue consists of a vertex and the sum of the weights (the preliminary criteria) of all edges on the shortest path from the starting vertex to that vertex. For example, in one embodiment, such weights may be the time required for travel between the two hubs or locations.

The priority queue containing the pairs of vertices and total weights is ordered by lowest total weight. In order to keep track of the total weight of any vertex in the network of vertices, a map is used where each key in the map is a vertex in the network of vertices and each value in the map is the sum of the weights of all the edges on the shortest path from the starting vertex to the corresponding vertex of that weight. In order to provide the ability to reconstruct the shortest path from the starting vertex to the destination vertex once the search algorithm has completed its search, another map is used where each key is a vertex and each value is the vertex that is the immediate predecessor of the corresponding vertex on the shortest path from the starting vertex to the destination vertex. In essence, the map of lowest total weights maps each vertex in the network of vertices to the minimum total weight, so far, of the path from the starting vertex to the specified vertex.

Initially, the priority queue contains only the starting vertex and its lowest total weight, which is zero. During each of the iterations of the search algorithm, the vertex-weight pair in the priority queue that has the minimum total weight among all of the vertex-weight pairs in the priority queue is greedily chosen. If there is a neighbor of a vertex whose total weight can be reduced by running the path through that vertex, then the neighbor's path and minimum weight is altered and the neighbor is added to the priority queue. Performing this type of operation will eventually yield the shortest path between a starting vertex and a destination vertex, if there is indeed a path between those two vertices in the network of vertices.

When starting off a search, the map of vertices to weights associates with each vertex in the network of vertices a very large total weight and the map of vertices to immediate predecessor vertices associated with each vertex in the network of vertices an empty vertex. These initializations are refined by mapping the starting vertex to a total weight of zero, by mapping the starting vertex to itself as its immediate predecessor, and by adding the starting vertex-weight of zero pair to the priority queue. Performing these actions completes the initialization phase of the search algorithm.

Suppose, in FIG. 1, that the shortest path from A to E needs to be found.

Table 1. Network of Vertices in which the Shortest Path from A to E is to be Found.

Initially, the vertex-weight pair priority queue, map of vertices to weights, and map of vertices to immediate predecessors are in the states as shown in FIG. 2.

TABLE 2
State of the vertex-weight and vertex-predecessor maps
and vertex-weight priority queue after initialization.

| | | Vertex-Weight |
|---|---|---|
| Vertex-Weight Map | Vertex-Predecessor Map | Priority Queue |
| A, 0.0 | A | <A, 0.0> |
| B, 1000000.0 | null | |
| C, 1000000.0 | null | |
| D, 1000000.0 | null | |
| E, 1000000.0 | null | |
| F, 1000000.0 | null | |
| G, 1000000.0 | null | |

After initializing, the search algorithm loops until the shortest path is found or the vertex-weight priority queue is empty. During the first iteration of this loop, the minimum vertex-weight pair, <A, 0.0>, is removed from the vertex-weight priority queue. Since this vertex-weight pair's weight, 0.0, is less than or equal to A's total weight value, the search algorithm iterates in an inner loop over the neighboring vertices of A. For each neighboring vertex, the map of vertices to weights and map of vertices to immediate predecessors are updated, and the neighboring vertex and its total weight to this point are added to the vertex-weight priority queue. After these operations, the vertex-weight map, vertex-predecessor map, and vertex-weight priority queue are in the states as shown in Table 3.

TABLE 3
State of the vertex-weight and vertex-predecessor maps,
and vertex-weight priority queue after the first iteration
of the other loop of the search algorithm.

| Vertex- | Vertex- | Vertex- |
|---|---|---|
| Weight Map | Predecessor Map | Weight Priority Queue |
| A, 0.0 | A | <C, 2.0> |
| B, 4.0 | A | <B, 4.0> |
| C, 2.0 | A | <E, 15.0> |
| D, 1000000.0 | null | |
| E, 15.0 | A | |
| F, 1000000.0 | null | |
| G, 1000000.0 | null | |

After the operations shown in Table 3, the outer loop of the search algorithm is executed for a second time. During this execution, the vertex-weight pair <C, 2.0> is removed from the vertex-weight priority queue and the inner loop of the search algorithm is iterated over the neighboring vertices of C. The only vertex in the network of vertices on an edge from C is D and the weight of that edge is 5.0. This weight added to the weight of C, which is 2.0, is 7.0, which is less than the total weight of D, which 1000000.0. So in the vertex-weight map, the total weight of D is upgraded to 7.0. After these operations, the vertex-weight map, vertex-predecessor map, and vertex-weight priority queue are in the states as shown in FIG. 4.

TABLE 4
State of the vertex-weight and vertex-predecessor maps,
and vertex-weight priority queue after the second iteration
of the outer loop of the search algorithm.

| | | Vertex-Weight |
|---|---|---|
| Vertex-Weight Map | Vertex-Predecessor Map | Priority Queue |
| A, 0.0 | A | <B, 4.0> |
| B, 4.0 | A | <D, 7.0> |
| C, 2.0 | A | <E, 15.0> |
| D, 7.0 | C | |
| E, 15.0 | A | |
| F, 1000000.0 | null | |
| G, 1000000.0 | null | |

After the operations shown in Table 4, the outer loop of the search algorithm is executed for a third time. During this execution, the vertex-weight pair <B, 4.0> is removed from the vertex-weight priority queue and the inner loop of the search algorithm is iterated over the neighboring vertices of B, which are D and E. After these operations, the vertex-weight map, vertex-predecessor map, and vertex-weight priority queue are in the states as shown in FIG. 5.

TABLE 5
State of the vertex-weight and vertex-predecessor maps,
and vertex-weight priority queue after the third iteration
of the outer loop of the search algorithm.

| | | Vertex-Weight |
|---|---|---|
| Vertex-Weight Map | Vertex-Predecessor Map | Priority Queue |
| A, 0.0 | A | <D, 5.0> |
| B, 4.0 | A | <D, 7.0> |
| C, 2.0 | A | <E, 14.0> |
| D, 5.0 | B | <E, 15.0> |
| E, 14.0 | B | |
| F, 1000000.0 | null | |
| G, 1000000.0 | null | |

At this point in the search process, the total weight of the lowest-weight path to D is 5.0 and the total weight of the lowest-weight path to E is 14.0. After the operations shown in Table 5, the outer loop of the search algorithm is executed for a fourth time. During this execution, the vertex-weight pair <D, 5.0> is removed from the vertex-weight priority queue and the inner loop of the search algorithm is iterated over the neighboring vertices of D, which are F and E. After these operations, the vertex-weight map, vertex-predecessor map, and vertex-weight priority queue are in the states as shown in FIG. 6.

TABLE 6
State of the vertex-weight and vertex-predecessor maps,
and vertex weight priority queue after the fourth iteration
of the outer loop of the search algorithm.

| | | Vertex-Weight |
|---|---|---|
| Vertex-Weight Map | Vertex-Predecessor Map | Priority Queue |
| A, 0.0 | A | <F, 5.0> |
| B, 4.0 | A | <D, 7.0> |
| C, 2.0 | A | <E, 8.0> |
| D, 5.0 | B | <E, 14.0> |
| E, 8.0 | D | <E, 15.0> |
| F, 5.0 | D | |
| G, 1000000.0 | null | |

After the operations shown in Table 6, the outer loop of the search algorithm is executed for a fifth time. During this execution, the vertex-weight pair <F, 5.0> is removed from vertex-weight priority queue and the inner loop of the search algorithm is iterated over the neighboring vertices of F, which are D and G. After these operations, the vertex-weight map, vertex-predecessor map, and vertex-weight priority queue are in the states as shown in Table 7.

TABLE 7
State of the vertex-weight and vertex-predecessor maps,
and vertex-weight priority queue after the fifth iteration
of the outer loop of the search algorithm.

| | | Vertex-Weight |
|---|---|---|
| Vertex-Weight Map | Vertex-Predecessor Map | Priority Queue |
| A, 0.0 | A | <D, 7.0> |
| B, 4.0 | A | <E, 8.0> |
| C, 2.0 | A | <G, 9.0> |
| D, 5.0 | B | <E, 14.0> |
| E, 8.0 | D | <E, 15.0> |
| F, 5.0 | D | |
| G, 9.0 | F | |

After the operations shown in Table 7, the outer loop of the search algorithm is executed for a sixth time. During this execution, the vertex-weight pair <D, 7.0> is removed from the vertex-weight priority queue. Due to the fact that the minimum total weight from A to D is recorded in the vertex-weight map as 5.0, the inner loop of the search algorithm is not iterated. After these operations, the outer loop of the search algorithm is executed for a seventh time. During this execution, the vertex-weight pair <E, 8.0> is removed from the vertex-weight priority queue. Since E is the vertex to which the shortest path from A is desired, the search process is complete. The reason why the search process is for sure complete at this point is because, if there had been another path to E with a total weight less than 8.0, the vertex-weight pair corresponding to that path would have been removed from the vertex-weight priority queue before the vertex-weight pair <E, 8.0>.

Since the search process is complete, the shortest path from A to E can be constructed as a LinkedList of vertices from the vertex-weight predecessor map. Starting with an empty LinkedList object, E is added to the beginning of the LinkedList, followed by D, which is the predecessor of E, followed by B, which is the predecessor of D, and finally followed by A, which is the predecessor of B. The final contents of the LinkedList object in then in order: A, B, D, E.

Although this is how the base search algorithm works, the algorithm is slightly modified such that the vertex-weight pairs in the vertex-weight map and vertex-weight priority queue and the vertex-predecessor pair in the vertex-predecessor map are modified to become triples with the third element in the triple specifying the mode of transportation used on the trip between vertices. If, for example, flight (F) and train (T) are chosen, the search algorithm only looks for Fs and Ts in the network of vertices. In this implementation of the search algorithm, the search algorithm even provides an option to pass an array of transportation types to the search algorithm so that all types in the array can be searched for in the network of vertices. This modification of the search algorithm also allows for the use of buses (B) and cars (C).

FIG. 7A illustrates one example of database 36 in the form of a graph. The graph consists of two parts; vertices and edges. A vertex represents an intermediate location, such as an airport or train station; an edge represents a trip or segment between them. Each edge has a weight associated with it, which is used in the algorithm. This graph is created once and loaded on each search; the search algorithm (described below) than searches through this graph in an attempt to find the best trip possible. Once this trip is found, the algorithm searches the database for specific trip information.

As indicated by step 616, search element 24 applies a base criteria to identify a set of trips that could be used to provide transportation from the origin location to the destination location.

As indicated by step 626, filtering element 28 applies secondary criteria. In particular, filter element 28 retrieves pricing information for each of the trips. Such pricing for modes of transportation is retrieved from either GDS database 628 or non-GDS pricing databases 630. As noted above, such non-pricing databases may be purchased or created especially for system 500. Such databases are created by contacting individual travel mode vendors or suppliers to gather such data. As indicated by step 632, filter element 28 further determines the availability of the trips. Such availability may be determined by accessing databases 620 and 622. Determination of pricing and availability may be determined in any order. Additional secondary criteria may also be applied to filtering element 28. Lastly, the results are displayed to the user using computing device 504. As the above, the process 600 may additionally involve booking in payment for a selected trip.

FIGS. 8A and 8B illustrate a flow diagram illustrating one example method 700 by which filtering element 26 of system 500 determines pricing for each segment of each trip and an entire trip as a whole. As indicated by steps 702, 704 and 706, system 500 prompts the user to initially indicate whether or not the trip is a one-way trip, is a round trip or includes multiple segments (segments where the traveler may spend several days at a location between segments). As indicated by steps 708, for a one-way trip, system 500 prices the cost for travel from a remote origin location (a location not normally serving as a hub or terminal for a mode of transportation (not an airport, not a train station, not a bus station, such as the home or base office of the traveler) to a terminal origin location TO (a location serving as a terminal or hub for a mode of transportation, such as a bus station, train station, airport. As indicated by step 710, for a one-way trip, system 500 further prices travel from the terminal origin TO to the terminal destination TD. As indicated by step 712, for a one-way trip, system 500 prices travel from the terminal origin TO to the terminal destination TD using a consolidator (a travel discounter as compared to directly from the carrier itself).

As indicated by step 714, for round trips, system 500 prices the cost of travel from the remote origin RO (the traveler's home or base office) terminal origin TO and also from a terminal origin TO to the remote origin RO. As indicated by steps 716 and 718, system 500 performs the same pricing steps as in step 710 in 712, respectively.

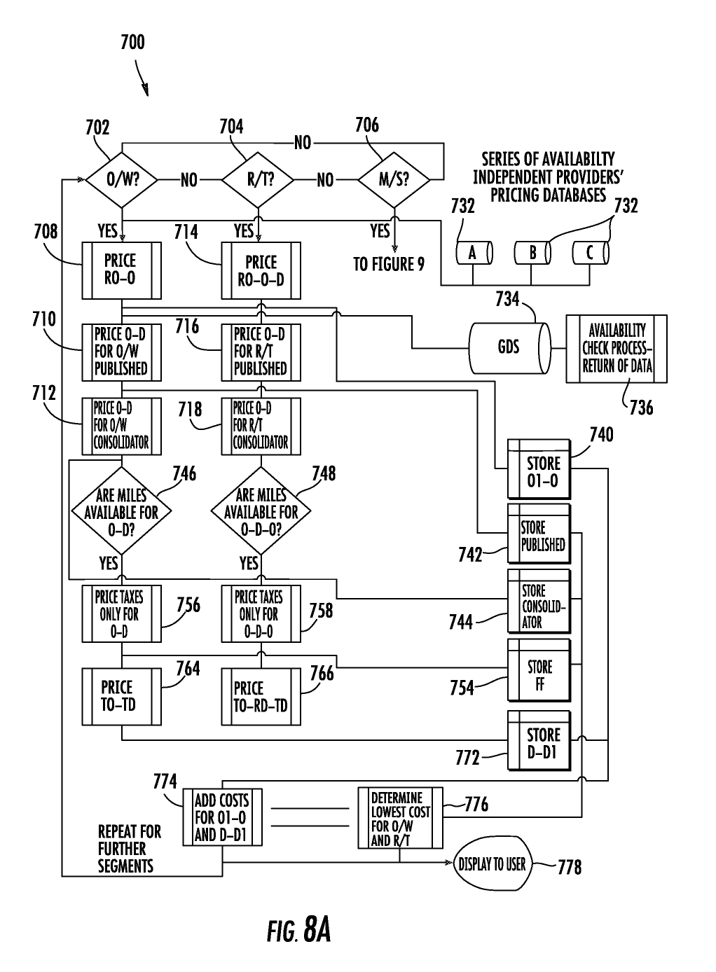

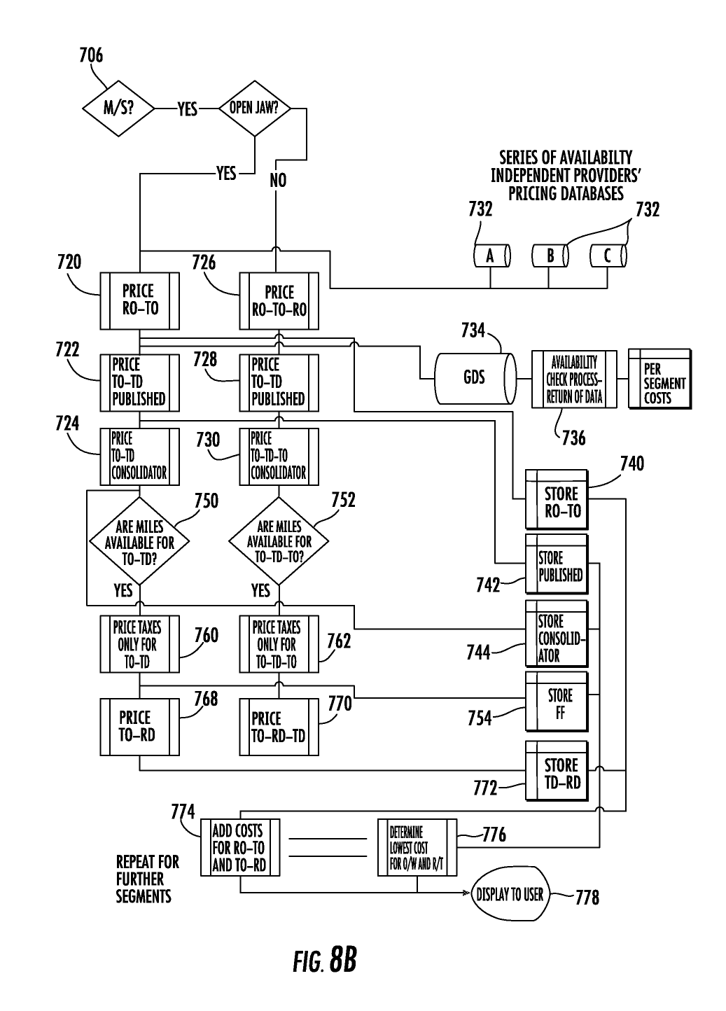

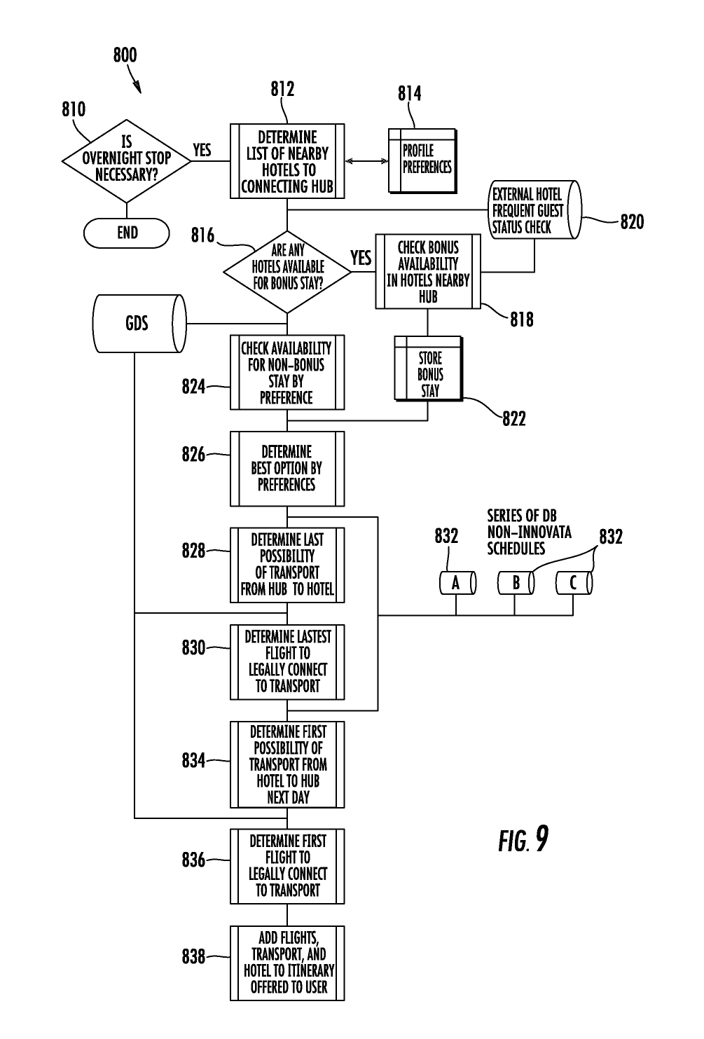

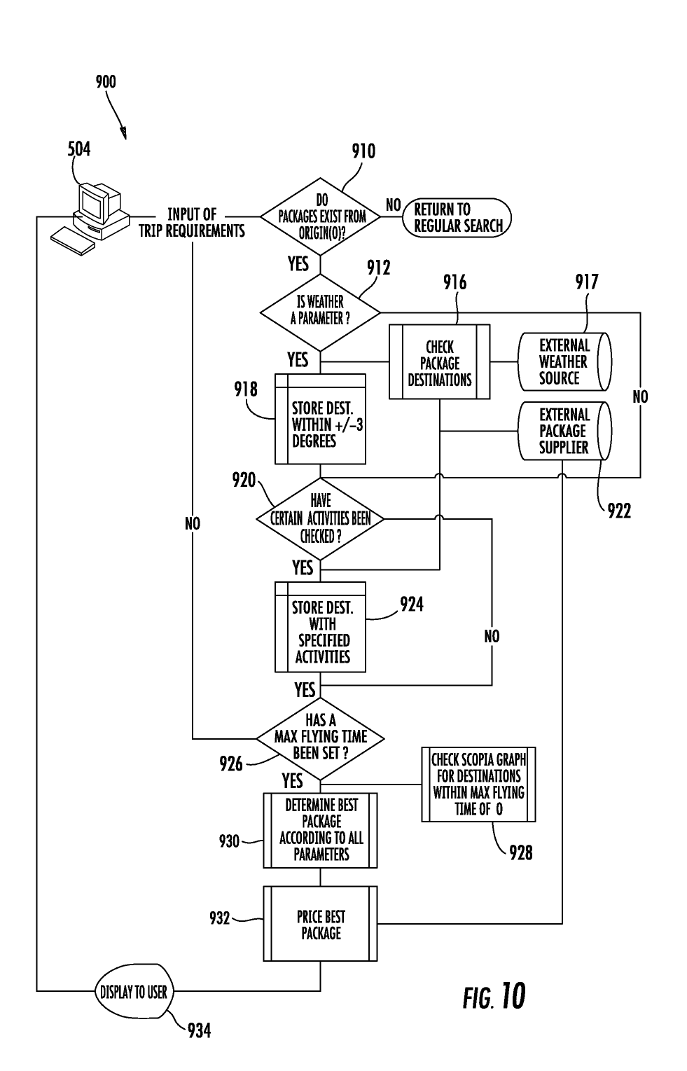

For multi-segment trips (trips where the traveler may spend more than one day between segments), as indicated by steps 720, 722, 724 and steps 726, 728 and 730 (shown in FIG. 9), system 500 also performs the same pricing steps as steps 714, 716 and 718, respectively. Such price information is acquired from available independent provider pricing databases 732 or from GDS 734 as part of the process, filtering element 28 further checks on the availability of such trips as indicated by step 706.

As indicated by steps 740, 742, 744, each of the prices are stored. As indicated by steps 746, 748, 750, 752, system 500 further checks whether frequent-flier miles are available for a particular segment being priced. As indicated by steps seven and 54 determination of whether frequent-flier miles are available for the ticker segment is stored. As indicated by steps 756, 758, 760 and 762, taxes each particular mode of travel for a particular segment of further taken into account. As indicated by steps 764, 766, 768 and 770, for each mode of transportation for each segment, system 500 further prices any travel from the terminal destination TD to the remote destination RD, whether it be a particular resort, hotel, bed-and-breakfast, park, remote business office or other remote destination not normally serving as a hub or terminal for a mode of transportation. As indicated by step 772, the pricing or costs for travel from the terminal destination to the remote destination.

As indicated by step 774, system 500 ads the costs of each of the segments of a trip including travel between the remote origin to the terminal origin, travel between the terminal destination and the remote destination and travel between the terminal origin location and the terminal destination location. The total cost of each of the segments is a total trip costs. As indicated by step 776, system 500 compares total cost of each trip to identify the pricing order of the analyzed trips. As indicated by step 778, the pricing of the various trips may be displayed to the user.

FIG. 9 illustrates a method 800 that trip planner 20th system 500 may carry out when there is an overnight stay between consecutive segments, such as when a first segment ends late in the day and a second statement begins the next morning or the next day. As indicated by step 810, when formulating trips from mode schedules, trip source 26 determines whether an overnight stop is necessary. As indicated by step 812, source 26 may determine a list of nearby hotels to be connecting hub or intermediate location. As indicated by step 816, as part of the evaluation, filter element 20 further determines whether any hotels reward bonuses for stays. As indicated in step 818, filtering element 28 further determines the availability of bonuses in hotels that are nearby the connecting hub or intermediate location. To do so, filtering element 28 may consult hotel databases or websites as indicated in step 820. As indicated in step 822, if bonuses or rewards are available for stays at particular hotels, this information is stored in a database. As indicated by step 824, filtering element 28 may further check the availability of hotels nearby the job or intermediate location, but which do not offer rewards. As indicated by step 826 filter element 28 compares all available hotels or overnight accommodations against any preferences identified by the traveler here with a particular search or a stored in his or her travel profile.

As indicated in steps 828-836, filtering element 28 further (1) determines whether there are acceptable modes of transportation or transport from the hub to the hotel (step 828), (2) identifies the latest possible mode of transportation arrival (the arrival of a flight, train) at the hub that may still allow sufficient time for the traveler to connect to the mode of transportation or transport to the hotel (step 830), (3) identify or determine the first possible mode of transportation or transport from the hotel to the hub or intermediate location the next day (step 834) and (4) determines the first mode of transportation the next day that the traveler may use and will have sufficient time to connect to for traveling the next segment of the trip. As indicated by step 838, filter element 28 includes the modes of transportation (see flight in the example), hotel transport and hotel itinerary as part of the trip offered to the user by output 30.

FIG. 10 is a flow diagram illustrating method 900 which may be carried out by system 503 at method 900 outlines a method for targets or goal oriented travel. Upon receiving goals or targets for a trip, search element 24 (shown in FIG. 1) initially determines what origin locations satisfy the goal or targets of the traveler. As indicated in step 910, search element 24 initially determines whether any packages exist from the origin location or a least a terminal origin location. As indicated in step 912, if packages exist, search element 24 determines from the traveler's input whether weather is a preference or parameter. As indicated by step 914, if weather is a parameter, search element 24 checks. Package destinations and identifies the weather at such occasions from an external weather source or database 916. As indicated by step nine and 18, search element 24 stores any destination within a predetermined range of temperatures of the target temperature. An example presented, search element 24 stores destinations that have an average high that is within 3 degrees of the target temperature. Another embodiment, this range may be increased or decreased.

As indicated by step 920, search element 24 initially determines whether the traveler has identified certain activities. Examples of activities include, but are not limited to, downhill skiing, hiking, a beach, mountain climbing, opera, symphony and the like. Other activities might be actual events such as a concert, fair or the like. As indicated by step 920, if activities have been selected as a target activity or a goal, search element 24 further consults a database or website 922 of the supplier of the travel packages to determine what travel packages satisfy the activity preference. As indicated by step 924, the travel packages that satisfy the request activities are stored in a database. At this point, search element 24 is identified a set of travel packages or a set of destinations that satisfy both a target temperature and are sufficiently close to target activities. Each of the destinations is used as part of a base criteria for a search.

Steps 926-932 are steps carried out by filtering element 28. Step 926 determines from the input secondary criteria whether a maximum flying or other travel time has been input. If so, filtering element 28 filters and removes those trips having travel times exceeding the maximum travel time as indicated by step 928. As indicated by step 930, filtering element 28 further applies additional user preferences or parameters (secondary criteria) to determine those packages or potential destinations that best satisfy the secondary criteria. As indicated by step 932, filtering element 28 further prices each of the packages, travel itineraries or trips as described above. As indicated by step 934, the results are output to the user on computing device 504.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
providing at least one database of trips between an origin location and a destination location, at least some of the trips each comprising:
a series of connected trip segments, each trip segment connected to an intermediate location between the origin location and the destination location, wherein each intermediate location is connected to only two of the trip segments and wherein at least two of the trip segments have different transportation modes; and;
applying one or more criteria to the trips of the at least one database; and
outputting one or more trips based on the applied criteria.

2. The method of claim 1, wherein the one or more criteria include availability of a transportation mode for every trip segment of a trip.

3. The method of claim 2, wherein the one or more criteria further comprise a second criteria of availability of a bonus for an available transportation mode of at least one trip segment.

4. The method of claim 3, wherein the one or more criteria include a third criteria of a minimal cost savings of using an available bonus.

5. The method of claim 2, wherein the one or more criteria include a second criteria of maximum layover time between adjacent trip segments.

6. The method of claim 1 further comprising comparing a total layover cost of each of the trips, wherein the total layover cost of each trip comprises a layover time between adjacent segments of a trip multiplied by an assigned hourly cost.

7. The method of claim 1, wherein outputting comprises sorting and ordering based upon one or more criteria.

8. The method of claim 1, wherein the one or more criteria include transportation mode exclusions.

9. The method of claim 1, wherein the trip segments include modes of transportation other than planes and trains.

10. The method of claim 1, wherein the at least one database is updated at least every predetermined time.

11. The method of claim 1, wherein the trips of the databases have a predetermined maximum layover time at intermediate locations between trip segments.

12. The method of claim 1, wherein the trips of the at least one database have a predetermined minimum layover time at specific intermediate locations between trip segments.

13. The method of claim 1, wherein the trips of the at least one database have a predetermined maximum total time for completing the trip.

14. The method of claim 1, wherein the database includes trips having consecutive segments beginning and ending on different days.

15. The method of claim 14, wherein the one or more criteria include available overnight accommodations at an intermediate location between the consecutive segments.

16. The method of claim 15, wherein the criteria include a second criteria of accommodation price for the available accommodations at the intermediate location.

17. The method of claim 1 further comprising requesting a range of departure dates from the origin location and a range of arrival dates at the destination location, wherein the at least one databases is limited to trips having a departure date from the origin location within the range of departure dates and having an arrival date at the destination location within the range of arrival dates.

18. The method of claim 1, wherein at least one of the trips being output includes an intermediate location, wherein the output is limited to a single segment extending to each intermediate location and a single segment extending from each intermediate location.

19. The method of claim 1 further comprising:
booking travel for different transportation modes associated with different segments of a trip; and
accepting a single payment for the different transportation modes.

20. The method of claim 1, wherein at least some of the one or more criteria. are from a stored travel profile.

21. The method of claim 1, further comprising usage of a discount plan from a pool of discounts.

22. A method comprising:
storing a set of one or more secondary criteria;
receiving base criteria comprising an origin location, a destination location, a range of travel departure dates from the origin location and a range of travel arrival dates at the destination location;
identifying a set of trips satisfying the base criteria, at least one of the trips comprising a series of connected trip segments, each trip segment connected to an intermediate location between the origin location and the destination location, wherein each intermediate location is connected to only two of the trip segments and wherein at least two of the trip segments have different transportation modes; and
identifying and outputting a subset of the set of trips that satisfy the stored secondary criteria and that are available.

23. An apparatus comprising:
an input element configured to receive basic criteria comprising an origin location, a destination location, a range of travel departure dates from the origin location and a range of travel arrival dates at the destination location;
a search element configured to identify a set of trips satisfying the base criteria, at least one of the trips comprising a series of connected trip segments, each trip segment connected to an intermediate location between the origin location and the destination location, wherein each intermediate location is connected to only two of the trip segments and wherein at least two of the trip segments have different transportation modes; and
a filtering element configured to identify and output a subset of the set of trips that satisfy the stored secondary criteria and that are available.
